(19) United States
(12) Patent Application Publication
(10) Pub. No.: US 2007/0180025 A1
(43) Pub. Date: Aug. 2, 2007

(54) Inter-device linkage method, device linkage control system, device linkage control program and terminal device

(75) Inventors: Yuichi Kobayakawa, Tokyo (JP); Hiroaki Nakamitsu, Kanagawa (JP); Hayashi Ito, Chiba (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/598,036

(22) PCT Filed: Feb. 20, 2004
(86) PCT No.: PCT/JP04/01985

§ 371 Date: Aug. 16, 2006

(51) Int. Cl. G06F 15/16

(52) U.S. Cl. 709/204

(57) ABSTRACT

There is provided an inter-device linkage method in a device linkage control system capable of adaptively providing information according to a user context while protecting user individual information. In this method, firstly, communication is performed directly between an information output device (20) and a user terminal (10). When communication is performed between the information output device (20) and the user terminal (10) information used for processing in the information output device (20) and the user terminal (10) is provided from an information providing server (30). The processes based on the information provided from the information providing server (30) are executed in the information output device (20) and the user terminal (10). The output from the information output device (20) and the output from the user terminal (10) by the processes executed have different contents.

### TECHNICAL FIELD

The present invention relates to an apparatus collaboration control system in which a plurality of apparatuses perform collaborative operations using a mutual communication as a trigger, and particularly, an apparatus collaboration control system in which a plurality of apparatuses collaborate with each other to realize an effective service.

### BACKGROUND ART

Recently, an overview of research on a next-generation information communication society has been reported in “Summary Report: Research Workshop on Future Prospect of Ubiquitous Network Technology” (Ministry of Internal Affairs and Communications, http;//www.soumu.go.jp/joho_tsusin/policyreports/cho usa/yubikitasu/020611_{—}2.html#TOP, Jun. 27, 2002). “Ubiquitous” is a Latin word meaning “omnipresent (existing everywhere).” Furthermore, a “ubiquitous network” represents an ideal image for future information communication in which, by connecting a variety of information communication infrastructures seamlessly, users can use information communication needed on site without any spatial/geographical constraints, no matter where the users are.

In a ubiquitous network, the range of user terminal apparatuses connecting to a network to exchange information is believed to expand remarkably. By not only connecting next-generation television and information home appliances, not to mention apparatuses such as a PC (personal computer), PDA (Personal Digital Assistance) and mobile telephone, to a network, but also using a chip device having a communication function, many articles such as a table, chair, lighting apparatus, car, clothes, ornament, advertising sign, and advertisement are connected to the network. These articles are expected to provide more convenient functions through information communications according to the usage.

Also, the ubiquitous network is able to intelligently grasp a situation and environment of the users and optimize the users' environment for the usage of the network based on the information.

Also, in the network of the ubiquitous age, since a variety of traditional services are provided using a network, individuals will be identified in real time, and thereby a firm security system which prevents the leakage of personal information can be realized.

In a ubiquitous network society having such a ubiquitous network, a mode of providing services customized to suit the user' demands is believed to be evolved into a further universalized mode of providing adaptive services in reaction to the user's situation (context).

One of the information delivery systems in accordance with the trend toward this ubiquitous network society is disclosed in Japanese Patent Application Laid-Open No. 2002-117118.

This system is a commodity sales mediation system which provides a wide range of commodity information that matches consumers' preferences at commodity stores. As shown in FIG. 1, this system is configured with non-contact IC card 1 that stores purchase history information on commodities which a user bought and personal information, commodity sales mediation apparatus 2 that reads the information from this non-contact IC card 1 and displays the commodity information to be mediated for the user, store server 3 that is connected to commodity sales mediation apparatus 2, and store head office server 5 and manufacturer servers 6a, 6b and 6c that are connected to store server 3 through Internet 4. Sales mediation apparatus 2 is provided with non-contact IC card reader/writer 2a that reads data from non-contact IC card 1, information communication apparatus 2c that exchanges information with store server 3, audio output apparatus 2d that outputs information of the commodity to be mediated with voice, display device 2e that outputs information of the commodity to be mediated with an image, and control apparatus 2b that controls the operation of commodity sales mediation apparatus 2.

The purchase history information of commodities which the user bought in the past is written into non-contact IC card 1 by a non-contact IC card reader/writer (not shown) which is attached to a register every time accounts of a commodity are adjusted. When the user carries this non-contact IC card 1 and enters a communication range of non-contact IC card reader/writer 2a of commodity sales mediation apparatus 2, purchase history information and personal information are read from non-contact IC card 1 to non-contact IC card reader/writer 2a. This information is sent to store server 3 and store server 3 determines a server to which the information is to be transmitted and transmits the information thereto. Manufacturer servers 6a to 6c which have received the purchase history information and personal information judge the preferences of the customer from the purchase history information and personal information and determine the commodity information to be mediated. This commodity information is processed, sent to commodity sales mediation apparatus 2 and outputted from audio output apparatus 2d or displayed on display device 2e.

In this way, this information delivery system is able to adaptively deliver the commodity information that matches the preferences of the consumer to the consumer who owns non-contact IC card 1 which stores purchase history information and personal information.

However, since this conventional information delivery system adopts a configuration whereby only commodity sales mediation apparatus 2 displays information, information which should be reported only to the user, for example, information concerned with privacy may not be displayed on display device 2e of commodity sales mediation apparatus 2 which can be seen by the other people. Therefore, the contents of services which can be delivered in this system cannot help but be limited.

Furthermore, information includes not only contents to be viewed but also setting information of equipment and control information such as a control program information, but the conventional system does not take into consideration services aimed at control information.

### DISCLOSURE OF INVENTION

It is therefore an object of the present invention to provide an apparatus collaboration control system which can provide various adaptive services efficiently and effectively through collaboration of a plurality of apparatuses.

An inter-apparatus collaboration method according to an embodiment of the present invention is a method executed between a first apparatus, second apparatus and third apparatus, having: a direct communication step of carrying out direct communication between the first apparatus and the second apparatus; a delivery step of delivering information used for processing by the first apparatus and second apparatus from the third apparatus when communication is carried out in the direct communication step; and an execution step of executing processing based on the information delivered in the delivery step by the first apparatus and second apparatus, wherein an output of the first apparatus and an output of the second apparatus through the processing executed in the execution step have different contents.

An inter-apparatus collaboration control system according to another embodiment of the present invention has: a first and second apparatuses that carries out direct communication with each other; and a third apparatus that delivers information used for processing by the first and second apparatuses when the first and second apparatuses carry out communication, wherein the first apparatus and second apparatus carry out the processing based on information provided by the third apparatus, and an output of the processing executed by the first apparatus and an output of the processing executed by the second apparatus have different contents.

An inter-apparatus collaboration control program according to a further embodiment of the present invention is a program for an inter-apparatus collaboration control system made up of a first apparatus, second apparatus and third apparatus, the inter-apparatus collaboration control program being for realizing a direct communication function that carries out direct communication between the first apparatus and second apparatus, a delivery function that delivers information used for processing at the first apparatus and second apparatus from the third apparatus when communication by the direct communication function is carried out and an execution function that executes the processing based on the information delivered from the delivery function at the first apparatus and second apparatus, wherein an output of the first apparatus through the processing executed by the execution function and an output of the second apparatus have different contents.

A terminal apparatus according to a still further embodiment of the present invention is a terminal apparatus having: a direct communication section that carries out direct communication with another terminal apparatus; an acquisition section that acquires information delivered from a server apparatus when communication is carried out by the direct communication section; and an execution section that executes processing based on the information acquired by the acquisition section, wherein an output of the processing executed by the execution section and an output of the another terminal apparatus through the processing based on the information delivered from the server apparatus to the another terminal apparatus have different contents.

### BRIEF DESCRIPTION OF DRAWINGS

FIG. 1 is a block diagram showing the configuration of a conventional apparatus collaboration control system;

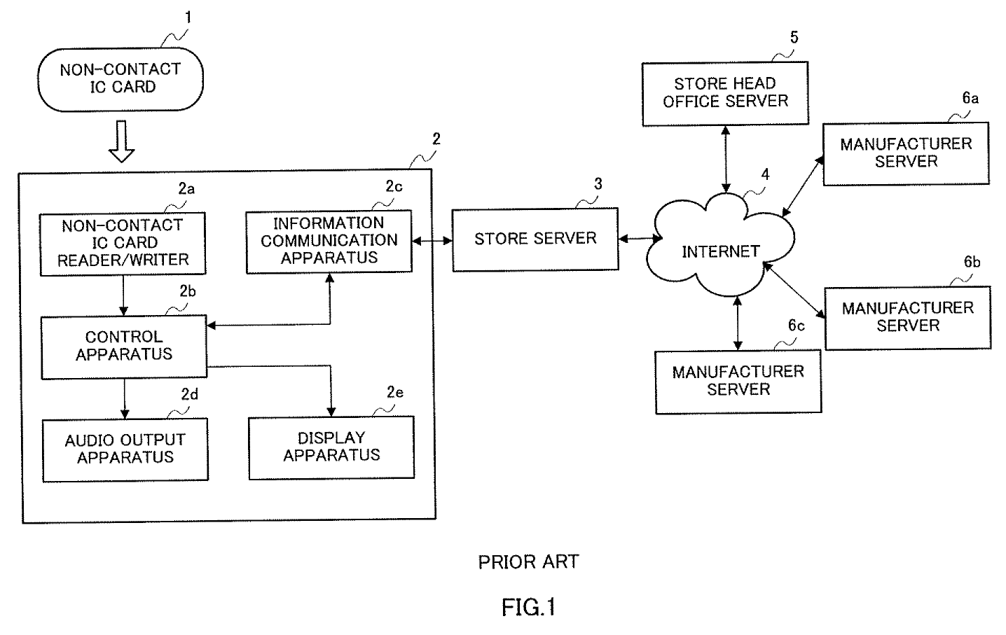

FIG. 2 is a block diagram showing the configuration of an apparatus collaboration control system according to embodiment 1 of the present invention;

FIG. 3 illustrates a data configuration diagram of management information managed by the information delivery server of the apparatus collaboration control system according to embodiment 1 of the present invention;

FIG. 4 illustrates a data configuration diagram of the management information managed by the information delivery server of the apparatus collaboration control system which delivers a quiz according to embodiment 1 of the present invention;

FIG. 5 is a block diagram showing the configuration of an apparatus collaboration control system according to embodiment 2 of the present invention;

FIG. 6 is a block diagram showing the configuration of an apparatus collaboration control system according to embodiment 3 of the present invention;

FIG. 7 is a first diagram schematically showing the configuration of an apparatus collaboration control system according to embodiment 4 of the present invention;

FIG. 8 is a second diagram schematically showing the configuration of the apparatus collaboration control system according to embodiment 4 of the present invention;

FIG. 9 is a first block diagram showing the configuration of the apparatus collaboration control system according to embodiment 4 of the present invention;

FIG. 10 is a second block diagram showing the configuration of the apparatus collaboration control system according to embodiment 4 of the present invention;

FIG. 11 is a third diagram schematically showing the configuration of the apparatus collaboration control system according to embodiment 4 of the present invention;

FIG. 12 is a fourth diagram schematically showing the configuration of the apparatus collaboration control system according to embodiment 4 of the present invention;

FIG. 13 is a block diagram showing the configuration of an apparatus collaboration control system according to embodiment 5 of the present invention;

FIG. 14 is a data configuration diagram of management information managed by the information delivery server of the apparatus collaboration control system according to embodiment 5 of the present invention;

FIG. 15 illustrates contents scores calculated by the user terminal of the apparatus collaboration control system according to embodiment 5 of the present invention;

FIG. 16 is a block diagram showing the configuration of an apparatus collaboration control system according to embodiment 6 of the present invention;

FIG. 17 is a data configuration diagram of management information managed by the information delivery server of the apparatus collaboration control system according to embodiment 6 of the present invention;

FIG. 18 illustrates contents scores for an information output apparatus calculated by the user terminal of the apparatus collaboration control system according to embodiment 6 of the present invention;

FIG. 19 illustrates contents scores for the user terminal calculated by the user terminal of the apparatus collaboration control system according to embodiment 6 of the present invention;

FIG. 20 is a block diagram showing the configuration of an apparatus collaboration control system according to embodiment 7 of the present invention;

FIG. 21 is a data configuration diagram of management information managed by the information delivery server of the apparatus collaboration control system according to embodiment 7 of the present invention;

FIG. 22 is a second data configuration diagram of management information managed by the information delivery server of the apparatus collaboration control system according to embodiment 7 of the present invention;

FIG. 23 is a block diagram showing the configuration of an apparatus collaboration control system according to embodiment 8 of the present invention;

FIG. 24 is a block diagram showing another configuration of the apparatus collaboration control system according to embodiment 8 of the present invention;

FIG. 25 is a data configuration diagram of management information managed by the information delivery server of the apparatus collaboration control system according to embodiment 8 of the present invention;

FIG. 26 schematically illustrates the configuration of an apparatus collaboration control system according to embodiment 9 of the present invention;

FIG. 27 is a data configuration diagram of management information managed by the information delivery server of the apparatus collaboration control system according to embodiment 9 of the present invention; and

FIG. 28 is a second data configuration diagram of management information managed by the information delivery server of the apparatus collaboration control system according to embodiment 9 of the present invention.

### BEST MODE FOR CARRYING OUT THE INVENTION

Embodiments of the present invention will be explained below in detail with reference to the accompanying drawings.

Note that this specification will refer to a section which carries out direct communication without any relay device as “direct communication section.” The direct communication section includes a communication section using IrDA, Bluetooth or the like. Furthermore, the direct communication section also includes an information transmission section configured with an RFID tag, barcode or two-dimensional code, any of which is referred to as “non-contact information transmission medium” in this specification and a reading section thereof.

### EMBODIMENT 1

In embodiment 1 of the present invention, an inter-apparatus collaboration control system will be explained in which both an information output apparatus that displays information and a user terminal carried by a user are provided with an information (contents) display function. In such a system, a case will be explained where, when the user enters a communication area of an information output apparatus, the information output apparatus and user terminal collaborate with each other to display contents.

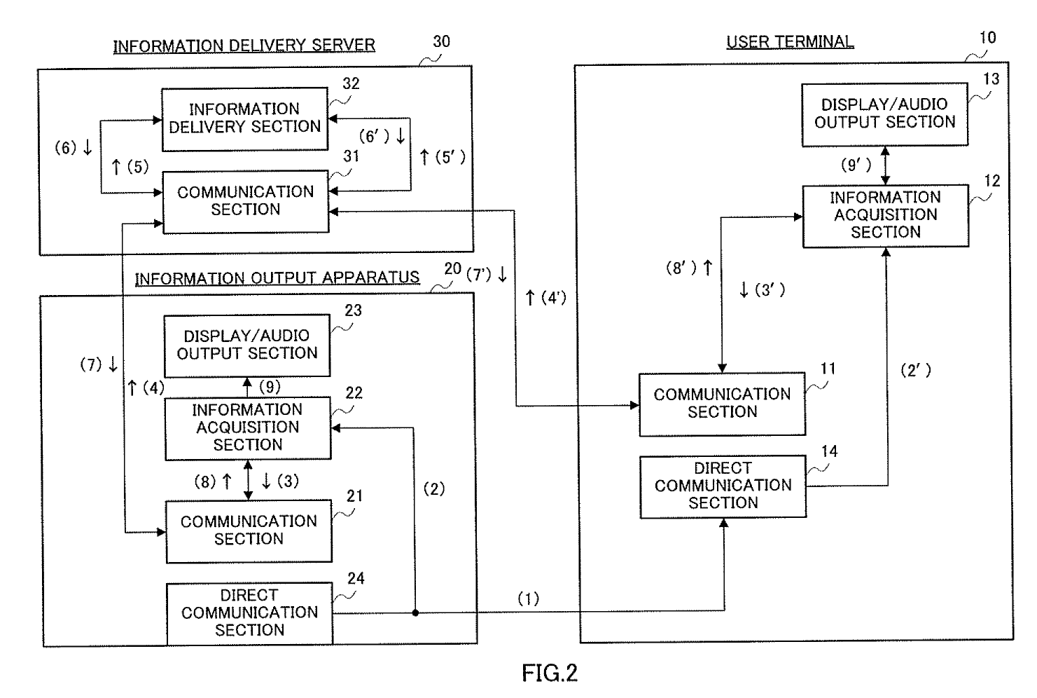

As shown in FIG. 2, this system is provided with user terminal 10 carried around by the user (e.g., mobile telephone or PDA), information output apparatus 20 such as a street display that displays information, information output apparatus 20 and information delivery server 30 that delivers contents to user terminal 10.

User terminal 10 is provided with direct communication section 14 for directly communicating with information output apparatus 20, communication section 11 for communicating with information delivery server 30, information acquisition section 12 that acquires information (contents) from information delivery server 30 and display/audio output section 13 that outputs the information acquired by information acquisition section 12 in an audio or image format.

Furthermore, information output apparatus 20 is provided with direct communication section 24 for directly communicating with user terminal 10, communication section 21 for communicating with information delivery server 30, information acquisition section 22 that acquires information (contents) to be displayed from information delivery server 30 and display/audio output section 23 that outputs information acquired by information acquisition section 22 in an audio or image format.

Furthermore, information delivery server 30 is provided with communication section 31 that communicates with user terminal 10 and information output apparatus 20 and information delivery section 32 that selects and delivers information (contents) to user terminal 10 and information output apparatus 20 respectively.

Direct communication sections 14 and 24 of user terminal 10 and information output apparatus 20 are the sections that carry out direct communication using IrDA or Bluetooth or the like without any relay device. Furthermore, communication sections 11, 21 and 31 of user terminal 10, information output apparatus 20 and information delivery server 30 may carry out direct communication or communication through a relay device.

Furthermore, information acquisition sections 12 and 22 of user terminal 10 and information output apparatus 20 are configured with a WWW browser provided with an information acquisition function and transmission function through an HTTP protocol. Furthermore, information delivery section 32 of information delivery server 30 is configured with, for example, a WWW server program and a CGI (Common Gateway Interface) program.

Next, the operation of this system will be explained.

Information output apparatus 20 sends out a radio wave from direct communication section 24 and calls for a response. When user terminal 10 which enters this communication range responds through direct communication section 14, information output apparatus 20 transmits its own identification information (information output apparatus ID) and URI (concept including URL and URN) of information delivery server 30 to user terminal 10 . Upon receiving this, user terminal 10 presents the information output apparatus ID to information delivery server 30 using communication section 11 to thereby request information delivery. Furthermore, information output apparatus 20 also presents its own identification information to information delivery server 30 using communication section 21 to thereby request information delivery.

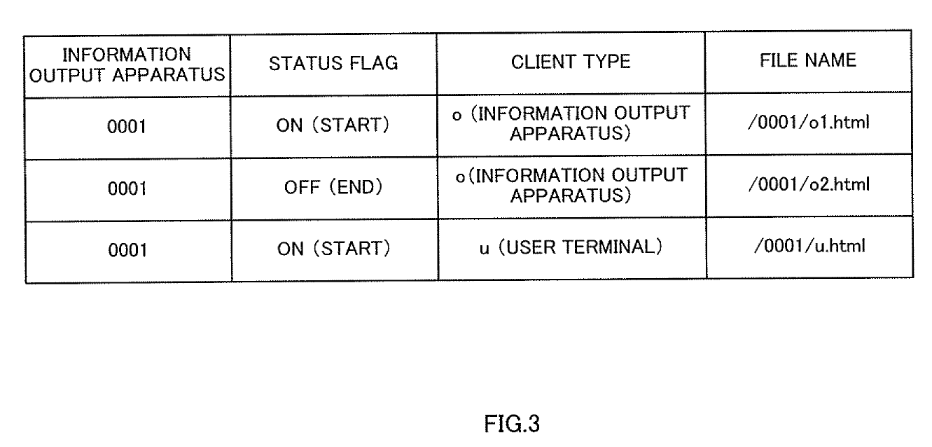

Information delivery section 32 of information delivery server 30 manages contents (file name and file entity of contents) specifying information output apparatus ID, status flag indicating a distinction between start/end of a response and client type indicating a distinction between information output apparatus/user terminal as shown in FIG. 3 Contents whose client type is “u” (user terminal) are information of contents to be informed to only the user and contents whose client typeis “o” (information out put apparatus) is information of contents that can be known to anybody in addition to the user.

Information delivery server 30 which has received a request for delivery of information from information output apparatus 20 and user terminal 10 outputs contents whose information output apparatus ID matches, whose client type is “o ” (information output apparatus) and whose status flag corresponds to “start” to information output apparatus 20 from among contents managed by information delivery section 32. Furthermore, information delivery server 30 outputs contents whose information output apparatus ID matches, whose client type is “u” (user terminal) and whose status flag corresponds to “start” to user terminal 10.

Information output apparatus 20 and user terminal 10 display information acquired from information delivery server 30 from display/audio output sections 23 and 13 respectively. Furthermore, when user terminal 10 goes out of the communication area and its response ends, information output apparatus 20 sends out an information delivery request whose status flag is set to “end” to information delivery server 30. Information delivery server 30 outputs contents whose information output apparatus ID matches, whose client type is “0 ” (information output apparatus) and whose status flag is set to “off” from among contents managed by information delivery section 32 to information output apparatus 20, and information output apparatus 20 displays the contents on display/audio output section 23.

In this way, when the user (that is, user terminal 10 being used by the user) approaches, information output apparatus 20 adaptively reacts to the situation and switches the display contents from ordinary display contents to contents in consideration of the user. Furthermore, information to be personally informed to the user is displayed only on display/audio output section 13 of user terminal 10.

FIG. 2 shows a processing flow in this apparatus collaboration control system using numerals in parentheses.
(1) Direct communication section 24 of information output apparatus 20 and direct communication section 14 of user terminal 10 start a response when the two come closer to and recognize each other. Direct communication section 24 of information output apparatus 20 transmits the information output apparatus ID of information output apparatus 20 and the URI of information delivery apparatus 30 to user terminal 10.
(2) Direct communication section 24 of information output apparatus 20 reports the occurrence of a response to information acquisition section 22.
(3) Information acquisition section 22 outputs an information acquisition request to communication section 21.
(4) Communication section 21 of information output apparatus 20 transmits the information acquisition request including the information output apparatus ID, status flag indicating “start” and client type indicating the information output apparatus to information delivery server 30.
(5) Communication section 31 of information delivery server 30 transmits the received information output apparatus ID, status flag (start) and client type (information output apparatus) to information delivery section 32 and issues an information acquisition request.
(6) Information delivery section 32 searches for contents from the management information (FIG. 3) using the information output apparatus ID, status flag (start) and client type (information output apparatus) as keys and returns contents of the search result to communication section 31.
(7) Communication section 31 transmits contents to communication section 21 of information output apparatus 20.
(8) In information output apparatus 20, communication section 21 transmits contents to information acquisition section 22.
(9) Information acquisition section 22 issues an instruction for displaying contents to display/audio output section 23 and displays the contents acquired from information delivery server 30.

On the other hand, user terminal 10 performs processing using the following procedure after (1).
(2′) Direct communication section 14 of user terminal 10 reports the information output apparatus ID and URI of information delivery apparatus 30 to information acquisition section 12.
(3′) Information acquisition section 12 specifies the information output apparatus ID to communication section 11 and indicates an information acquisition request to information delivery server 30.
(4′) Communication section 11 transmits an information acquisition request including the information output apparatus ID, status flag (start) and client type (user terminal) to information delivery server 30.
(5′) Communication section 31 of information delivery server 30 receives this information acquisition request, transmits the information output apparatus ID, status flag (start) and client type (user terminal) to information delivery section 32 and transmits the information acquisition request.
(6′) Information delivery section 32 searches for contents from the management information (FIG. 3) using the information output apparatus ID, status flag (start) and client type (user terminal) as keys and returns contents of the search result to communication section 31.
(7′) Communication section 31 transmits contents to user terminal 10.
(8′) Communication section 11 of user terminal 10 receives the contents and transmits the contents to information acquisition section 12.
(9′) Information acquisition section 12 transmits the contents to display/audio output section 13 and display/audio output section 13 displays the contents.

Furthermore, when the response of direct communication section 14 of user terminal 10 ends, direct communication section 24 of information output apparatus 20 reports the end of the response to information acquisition section 22. At this time, as in the case of (3), information acquisition section 22 issues an information acquisition request to communication section 21 and communication section 21 transmits the information acquisition request including the information output apparatus ID, status flag (end) and client type (information output apparatus) to information delivery server 30.

Steps in (4) to (9) are subsequently carried out and display/audio output section 23 of information output apparatus 20 displays contents for the case where there is no response from the user terminal (no user terminal is located nearby.)

Here, the case has been shown where information output apparatus 20 fetches contents from information delivery server 30 every time there is a response from user terminal 10. However, information output apparatus 20 may also cache contents acquired from information delivery server 30. This eliminates the necessity for information output apparatus 20 to access information delivery server 30 and acquire contents every time.

Next, as a specific example of this apparatus collaboration control system, a case where information output apparatus 20 issues a quiz and displays the answer on the user terminal will be explained.

This information output apparatus 20 displays questions of a quiz. When the user approaches information output apparatus 20, a message “See the user terminal for the answer,” is displayed and the answer of the quiz is displayed on user terminal 10 at hand.

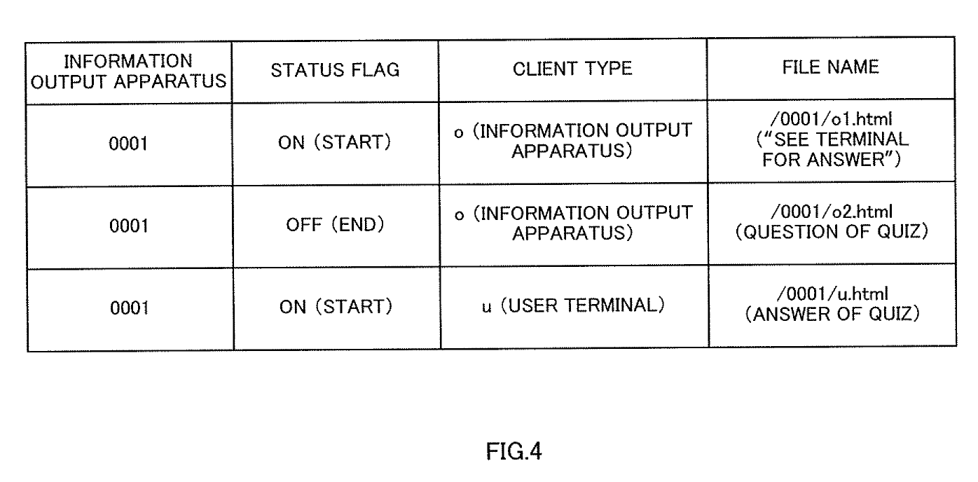

Management information shown in FIG. 4 is registered in information delivery section 32 of information delivery server 30.

Information output apparatus 20 stores in advance the URI of information delivery server 30, encodes the information output apparatus ID, status flag and client type to be included in the information acquisition request for information delivery server 30 in a URL argument specifying format, or stores them in a BODY section of a POST method and transmits them to information delivery server 30 (WWW server).

Now, suppose:
URI of information delivery server: http://www . . . /info. cgi
Information output apparatus ID: 0001
Status flag; ON (start)
Client type: o (information output apparatus).
   Then, the URI specification in this case will be as follows:
http://www . . . /info.cgi?oid=0001&status=on& client=o

When user terminal 10 responds, information output apparatus 20 transmits this URI to information delivery server 30.

Information delivery section 32 of information delivery server 30 searches for the table in FIG. 4 based on the information output apparatus ID, status flag and client type specified by the URI arguments and returns contents:/0001/o1.html (“See the user terminal for the answer”) as a result.

Information output apparatus 20 displays the obtained HTML contents on display/audio output section 23 (WWW browser). For that reason, the display of information output apparatus 20 changes to a display “See the user terminal for the answer.”

On the other hand, from the
URI of information delivery server: http://www . . . /info.cgi
information output apparatus ID: 0001 and
status flag: ON (start)
client type: u(user terminal)
   acquired from information output apparatus 20, user terminal 10 transmits the following URI to information delivery server 30.
http://www . . . /info.cgi?oid=0001&status=on& client=u

Information delivery section 32 of information delivery server 30 searches for the table in FIG. 4 based on the information output apparatus ID, status flag and client type specified by the URI arguments and returns contents:/0001/u.html (answer of the quiz). User terminal 10 which has acquired this displays it on the WWW browser. The subsequent changes will be made using the normal WWW browser functions.

Furthermore, when the response of user terminal 10 ends, information output apparatus 20 transmits the next URI whose status flag is set to OFF (end) to information delivery server 30.
http://www . . . /info.cgi?oid=0001&status-off &client=o

Information delivery section 32 of information delivery server 30 searches for the table in FIG. 4, returns contents:/0001/o2.html (question of the quiz) as a result and displays the question of the quiz on information output apparatus 20.

In this way, in this apparatus collaboration control system, with direct communication between the information output apparatus and user terminal as a trigger, the information output apparatus and user terminal collaborate with each other and can adaptively display information according to the user's situation. The collaboration between this information output apparatus and user terminal makes it possible to distribute information to be personally transmitted to the user to the user terminal and distribute information that may be known to the other people to the information output apparatus and display them respectively, and therefore, it is possible to diversify information contents delivered and efficiently present the information.

Here, the case where the information delivery section is disposed on information delivery server 30 has been explained, but it is also possible to dispose the information delivery section on information output apparatus 20 or user terminal and deliver information to be displayed on the user terminal from this information delivery section.

Furthermore, the case where information output apparatus 20 transmits the URI of information delivery server 30 to user terminal 10 has been explained, but user terminal 10 may also store in advance the URI of information delivery server 30. In this case, in (1), direct communication section 24 of information output apparatus 20 which has communicated with user terminal 10 transmits only the information output apparatus ID to user terminal 10.

Furthermore, the case where user terminal 10 or information output apparatus 20 transmits an information acquisition request including the client type or status flag to information delivery server 30 has-been explained here. However, instead of transmitting such an information acquisition request, it is also possible to change the URI of information delivery server 30 to be accessed according to the client type and response status.

For example, when client type=u, response status=start, “http://www . . . /info_client_start.cgi” is accessed.

Furthermore, when client type=o, response status=start, “http://www . . . /info_object_start.cgi” is accessed.

Furthermore, when client type=o, response status=end, “http://www . . . /info_object_end.cgi” is accessed.

Furthermore, the display of a quiz and answer thereof has been described here, but it is possible to apply this to other various information delivery services.

For example, a mode is possible in which detailed information of an advertisement is displayed on user terminal 10 and when an advertisement of a car is displayed, information output apparatus 20 (display) may display a moving image and overview of performance of a running vehicle, display detailed specifications (piston displacement, horse power or the like) or display a screen for requesting information materials on the user terminal so as to deliver detailed information when the user operates the user terminal, thereby making it possible to enhance advertising effects.

Furthermore, with communication with user terminal 10 as a trigger, information output apparatus 20 (display) can display an advertisement in which a car on a screen starts to move or sounds start to come out to thereby capture the user's attention. The status of such an advertisement can be changed by changing the contents to be displayed.

### EMBODIMENT 2

In embodiment 2 of the present invention, an apparatus collaboration control system will be explained in which user terminal 10 acquires contents to be displayed from information delivery server 30 through information output apparatus 20. The apparatus collaboration control system according to this embodiment has a basic configuration similar to that of embodiment 1, and therefore the same or corresponding components are assigned the same reference numerals and detailed explanations thereof will be omitted.

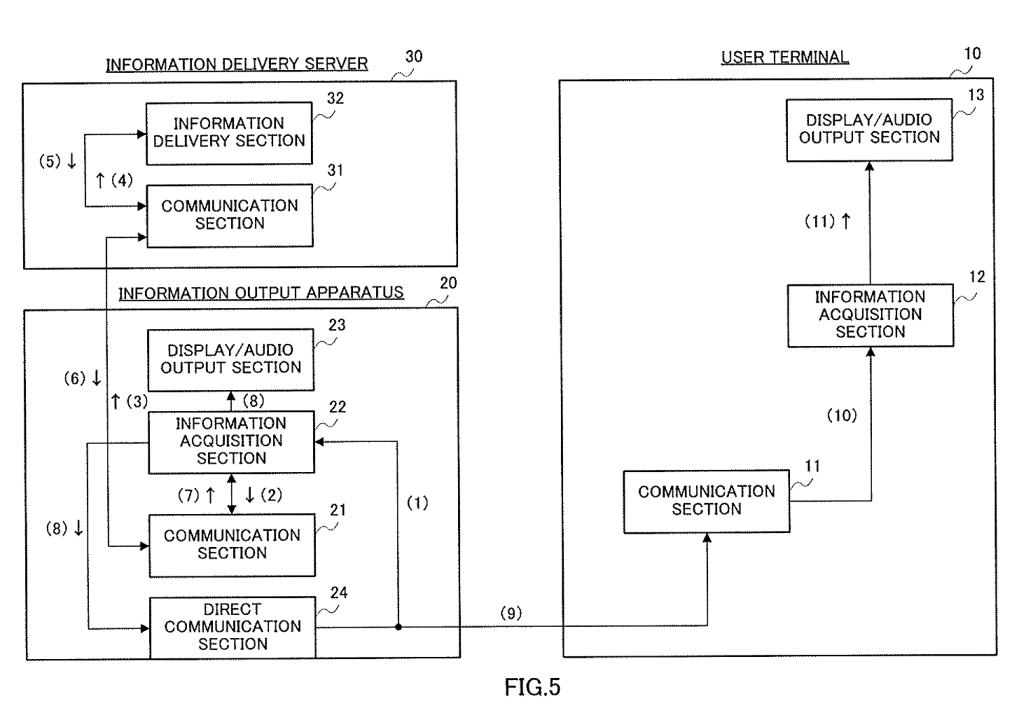

As shown in FIG. 5, in this system, user terminal 10 has no section for communicating with information delivery server 30. The rest of the configuration is the same as that of embodiment 1 (FIG. 2 ).

Next, the operating procedure of this system will be explained.
(1) When direct communication section 24 of information output apparatus 20 recognizes a response from direct communication section 14 of user terminal 10 which has entered the communication range, direct communication section 24 reports the occurrence of the response to information acquisition section 22.
(2) Information acquisition section 22 issues an information acquisition request to communication section 21.
(3) Communication section 21 of information output apparatus 20 transmits an information acquisition request including an information output apparatus ID, status flag indicating “start” and client type indicating information output apparatus 20 and user terminal 10 to information delivery server 30.
(4) Communication section 31 of information delivery server 30 transmits the received information output apparatus ID, status flag (start) and client type (information output apparatus and user terminal) to information delivery section 32 and transmits the information acquisition request.
(5) Information delivery section 32 searches for contents from the management information (FIG. 3) using the information output apparatus ID, status flag (start) and client type (information output apparatus and user terminal) as keys and returns contents of the search result to communication section 31.
(6) Communication section 31 transmits contents for the information output apparatus and contents for the user terminal to communication section 21 of information output apparatus 20.
(7) Communication section 21 of information output apparatus 20 transfers the contents to information acquisition section 22.
(8) Information acquisition section 22 passes contents for information output apparatus 20 to display/audio output section 23 and display/audio output section 23 displays the contents. Furthermore, information acquisition section 22 passes contents for user terminal 10 to direct communication section 24 and instructs transmission of the contents to user terminal 10.
(9) Direct communication section 24 transmits contents for user terminal 10 to user terminal 10.
(10) Direct communication section 11 of user terminal 10 passes the received contents to information acquisition section 12,
(11) Information acquisition section 12 outputs the contents to display/audio output section 23 and displays the contents.

In this system, user terminal 10 need not include any section for communicating with information delivery server 30, and therefore it is possible to simplify the configuration.

### EMBODIMENT 3

In embodiment 3 of the present invention, an apparatus collaboration control system will be explained in which information output apparatus 20 acquires contents to be displayed from information delivery server 30 through user terminal 10. The apparatus collaboration control system according to this embodiment has a basic configuration similar to that of embodiment 1, and therefore the same or corresponding components are assigned the same reference numerals and detailed explanations thereof will be omitted.

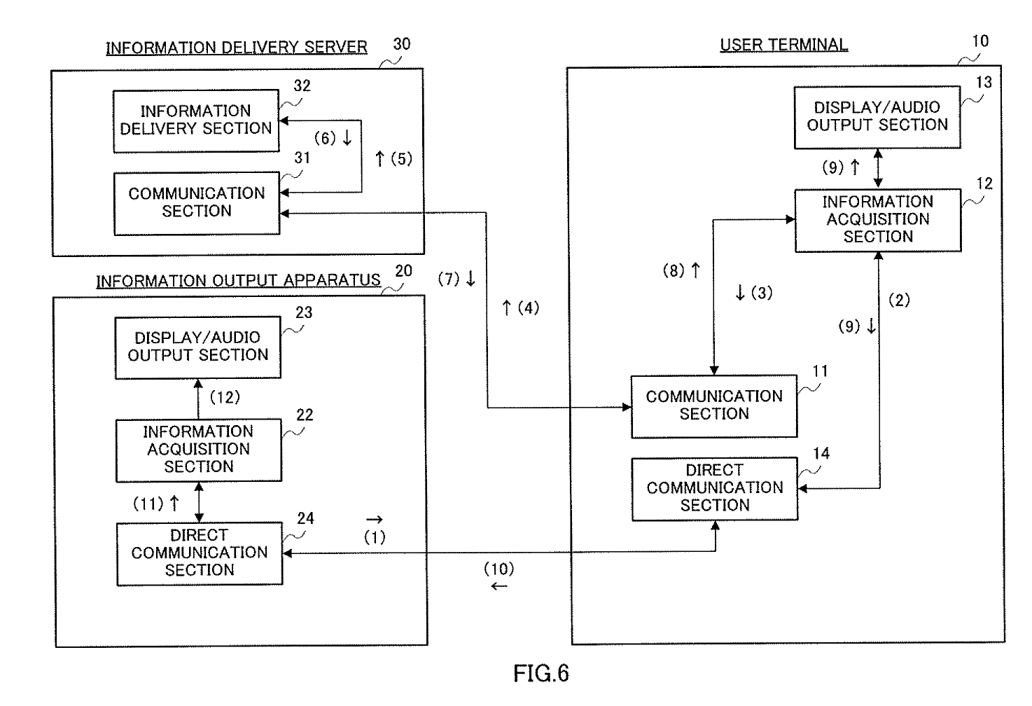

In this system, as shown in FIG. 6, information output apparatus 20 has no section for communication with information delivery server 30. The rest of the configuration is the same as that of embodiment 1 (FIG. 2)

Next, the operating procedure of this system will be explained.
(1) When direct communication section 24 of information output apparatus 20 recognizes a response from direct communication section 14 of user terminal 10 which has entered the communication range, it transmits the information output apparatus ID and URI of information delivery apparatus 30 to user terminal 10.
(2) Direct communication section 14 of user terminal 10 passes the information obtained from information output apparatus 20 to information acquisition section 12,
(3) Information acquisition section 12 issues an information acquisition request to communication section
(4) Communication section 11 transmits an information acquisition request including an information output apparatus ID, status flag indicating “start” and client type indicating information output apparatus 20 and user terminal 10 to information delivery server 30.
(5) Communication section 31 of information delivery server 30 transmits the received information output apparatus ID, status flag (start) and client type (information output apparatus and user terminal) to information delivery section 32 and transmits the information acquisition request.
(6) Information delivery section 32 searches for contents from the management information (FIG. 3) using the information output apparatus ID, status flag (start) and client type (information output apparatus and user terminal) as keys and returns contents of the search result to communication section 31.
(7) Communication section 31 transmits contents for the information output apparatus and contents for the user terminal to communication section 11 of user terminal 10.
(8) Communication section 11 of user terminal 10 transfers the contents to information acquisition section 12.
(9) Information acquisition section 12 passes contents for user terminal 10 to display/audio output section 13 and display/audio output section 13 displays the contents. Furthermore, information acquisition section 12 passes contents for information output apparatus 20 to direct communication section 14 and instructs transmission of the contents to information output apparatus 20.
(10) Direct communication section 14 transmits the contents for information output apparatus 20 to information output apparatus 20.
(11) Direct communication section 24 of information output apparatus 20 passes the received contents to information acquisition section 22,
(12) Information acquisition section 22 outputs the contents to display/audio output section 23 and displays the contents.

In this system, information output apparatus 20 need not have any section for communicating with information delivery server 30 and can thereby simplify the configuration.

### EMBODIMENT 4

In embodiment 4 of the present invention, a case will be explained where a section for reading an RFID tag and RFID tag is used as the direct communication section. The RFID tag can be provided on either the information output apparatus 20 side or user terminal 10 side. The apparatus collaboration control system in this embodiment has a basic configuration similar to that of embodiment 1, and therefore the same or corresponding components are assigned the same reference numerals and detailed explanations thereof will be omitted.

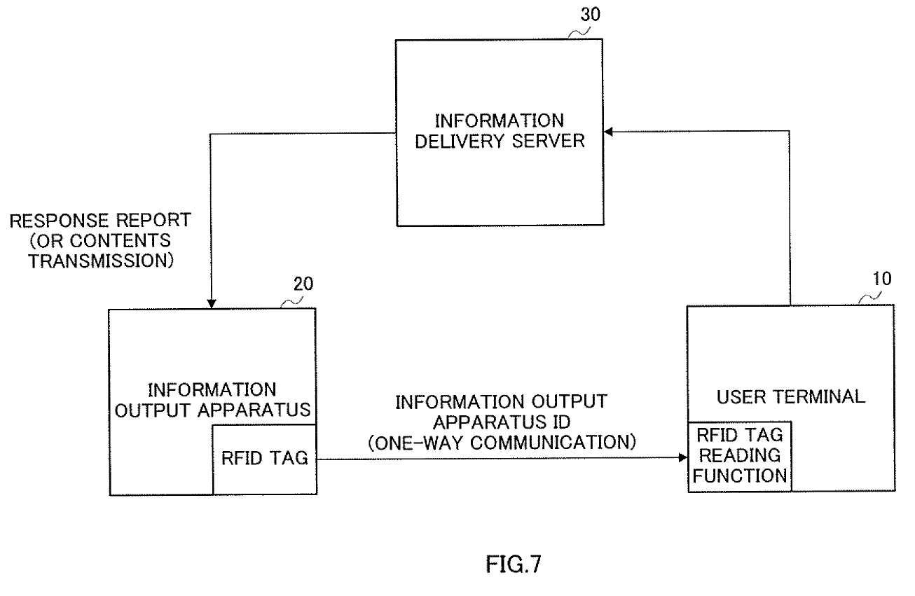

FIG. 7 shows a case where an RFID tag is provided on information output apparatus 20 and an RFID tag reading function is provided on user terminal 10. The RFID tag stores information of the information output apparatus ID and URI of information delivery server 30. User terminal 10 reads the information using the RPID tag reading function and transmits an information acquisition request including the information output apparatus ID to information delivery server 30.

Upon receiving this, information delivery server 30 transmits contents for the user terminal to user terminal 10 and also transmits contents for reporting a response or contents for the information output apparatus to information output apparatus 20. When information output apparatus 20 receives the report of the response, it transmits an information acquisition request to information delivery server 30 again and acquires contents for the information output apparatus. User terminal 10 and information output apparatus 20 which have acquired the contents display the contents from the display/audio output section.

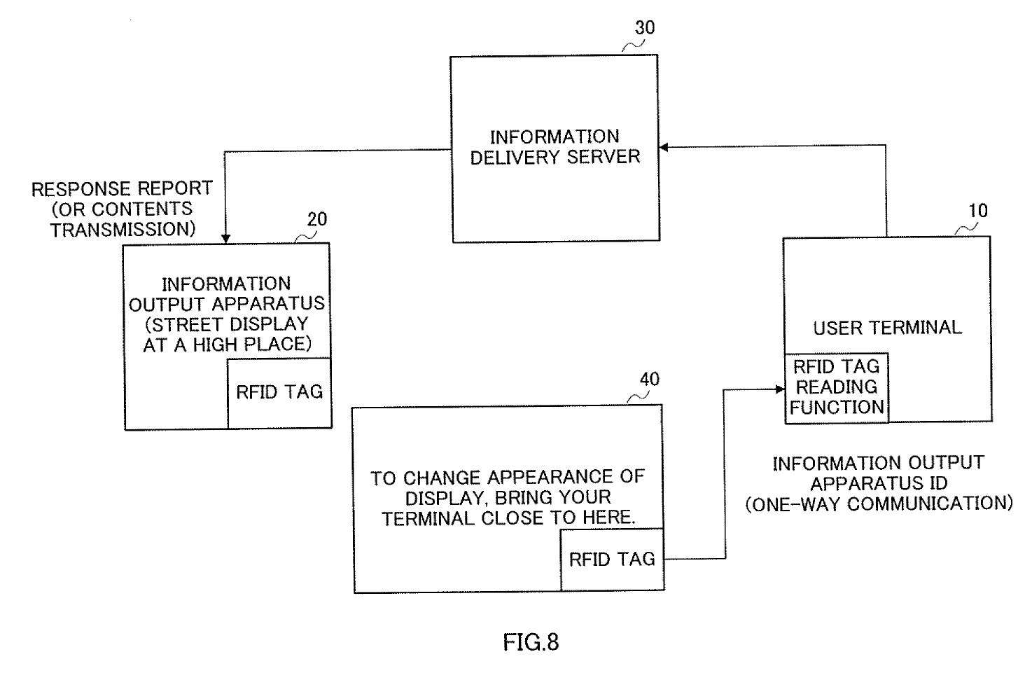

Furthermore, the RFID tag associated with this information output apparatus 20 may also be disposed on an object near information output apparatus 20 instead of being disposed on the body section of information output apparatus 20. As shown in FIG. 8, when information output apparatus 10 is a street display at a high place on the street, for example, the user cannot bring user terminal 10 closer to information output apparatus 10, but by disposing the RFID tag associated with the street display on a bulletin board 40 disposed at the foot of the street display, the user can bring user terminal 10 closer to the REID tag, and can thereby change the street display.

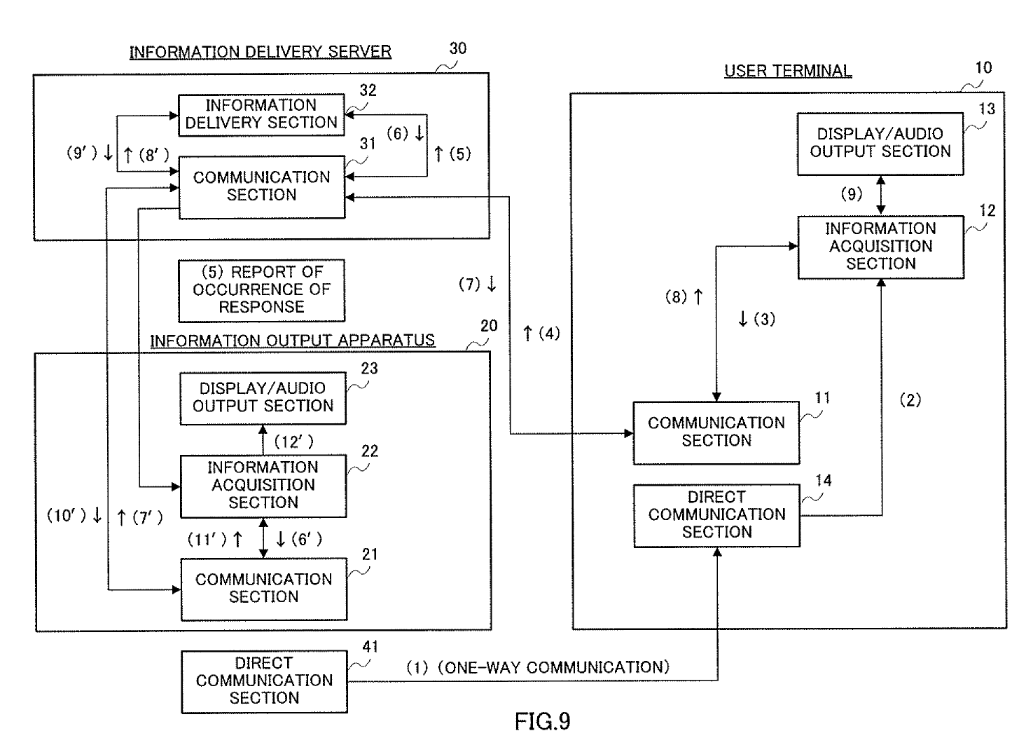

FIG. 9 shows a case where direct communication section 41 made up of an RFID tag is provided outside information output apparatus 10 (that is, provided separately) and processing steps when a response report is sent from information delivery server 30 to information output apparatus 20.
(1) Direct communication section 14 (RFID tag reading function) of user terminal 10 reads an information output apparatus ID and URI of information delivery apparatus 30 from direct communication section 41 (RFID tag).
(2) Direct communication section 14 of user terminal 10 passes the information acquired from direct communication section 41 (RFID tag) to information acquisition section 12,
(3) Information acquisition section 12 issues an information acquisition request to communication section
(4) Communication section 11 transmits the information acquisition request including the information output apparatus ID, status flag indicating “start” and client type indicating user terminal 10 to information delivery server 30.
(5) Communication section 31 of information delivery server 30 transmits the received information output apparatus ID, status flag (start) and client type (user terminal) to information delivery section 32 to transmit the information acquisition request and reports the occurrence of a response to information acquisition section 22 of information output apparatus 20.
(6) Information delivery section 32 searches for contents from the management information (FIG. 3) using the information output apparatus ID, status flag (start) and client type (user terminal) as keys and returns contents of the search result to communication section 31
(7) Communication section 31 transmits contents for the user terminal to communication section 11 of user terminal 10.
(8) Communication section 11 of user terminal 10 transfers the contents to information acquisition section 12.
(9) Information acquisition section 12 passes the contents for user terminal 10 to display/audio output section 13 and display/audio output section 13 displays the contents.

On the other hand,
(6′) Upon receiving the report of the occurrence of the response, information acquisition section 22 of information output apparatus 20 issues an information acquisition request to communication section 21,
(7′) Communication section 21 transmits the information acquisition request including the information output apparatus ID, status flag indicating “start” and client type indicating information output apparatus 20 to information delivery server 30.
(8′) Communication section 31 of information delivery server 30 transmits the received information output apparatus ID, status flag (start) and client type (information output apparatus) to information delivery section 32 and transmits the information acquisition request.
(9′) Information delivery section 32 searches for contents from the management information (FIG. 3) using the information output apparatus ID, status flag (start) and client type (information output apparatus) as keys and returns contents of the search result to communication section 31,
(10′) Communication section 31 transmits contents for the information output apparatus to communication section 21 of information output apparatus 20.
(11′) Communication section 21 of information output apparatus 20 transfers the contents to information acquisition section 22.
(12′) Information acquisition section 22 passes the contents for information output apparatus 20 to display/audio output section 23 and display/audio output section 23 displays the contents.

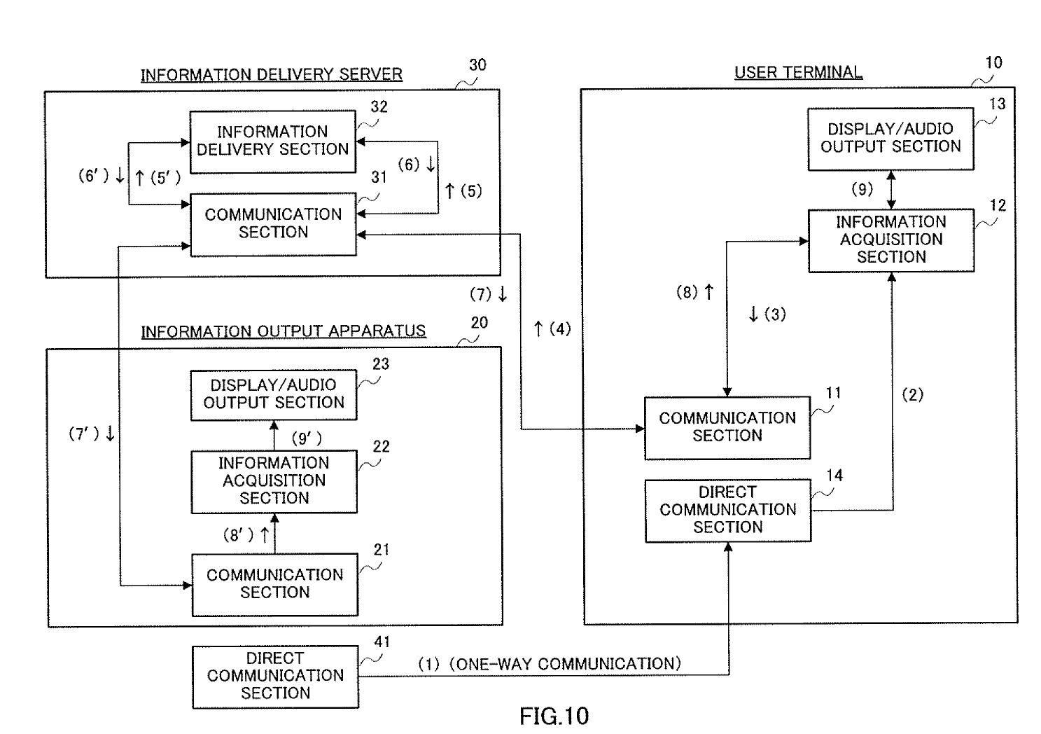

Furthermore, FIG. 10 shows processing steps when direct communication section 41 made up of an RFID tag is provided outside information output apparatus 20 and contents for information output apparatus 20 are directly sent from information delivery server 30 to information output apparatus 20.

Here, steps from (1) to (9) are the same as those in FIG. 9 except in that communication section 31 of information delivery server 30 sends no report of the occurrence of a response to information output apparatus 20 in (5).
(5′) Communication section 31 of information delivery server 30 transmits an information acquisition request including information output apparatus ID, status flag (start) and client type (information output apparatus) to information delivery section 32 instead of sending the report of the occurrence of a response
(6′) Information delivery section 32 searches for contents from the management information (FIG. 3) using the information output apparatus ID, status flag (start) and client type (information output apparatus) as keys and returns contents of the search result to communication section 31.
(7′) Communication section 31 transmits contents for the information output apparatus to communication section 21 of information output apparatus 20.
(8′) Communication section 21 of information output apparatus 20 transfers the contents to information acquisition section 22.
(9′) Information acquisition section 22 passes contents for information output apparatus 20 to display/audio output section 23, and display/audio output section 23 display the contents.

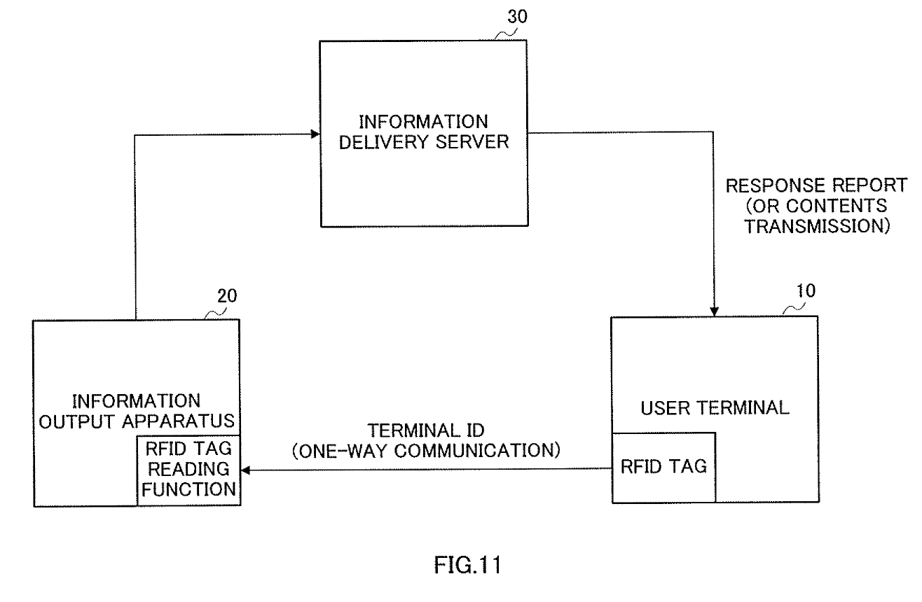

Furthermore, FIG. 11 shows a case where an RFID tag is provided on user terminal 10 and an RFID tag reading function is provided on information output apparatus 20. This RFID tag stores ID information of user terminal 10 and address information of user terminal 10 and information output apparatus 20 reads the information using the RFID tag reading function and transmits an information acquisition request including the information output apparatus ID and terminal ID to information delivery server 30.

Upon receiving this, information delivery server 30 sends out the contents for information output apparatus 20 to information output apparatus 20 and sends out a response report or the contents for user terminal 10 to user terminal 10. When user terminal 10 receives the response report, user terminal 10 transmits the information acquisition request to information delivery server 30 again and acquires the contents for user terminal 10. User terminal 10 and information output apparatus 20 which have acquired the contents display the contents from display/audio output section 23.

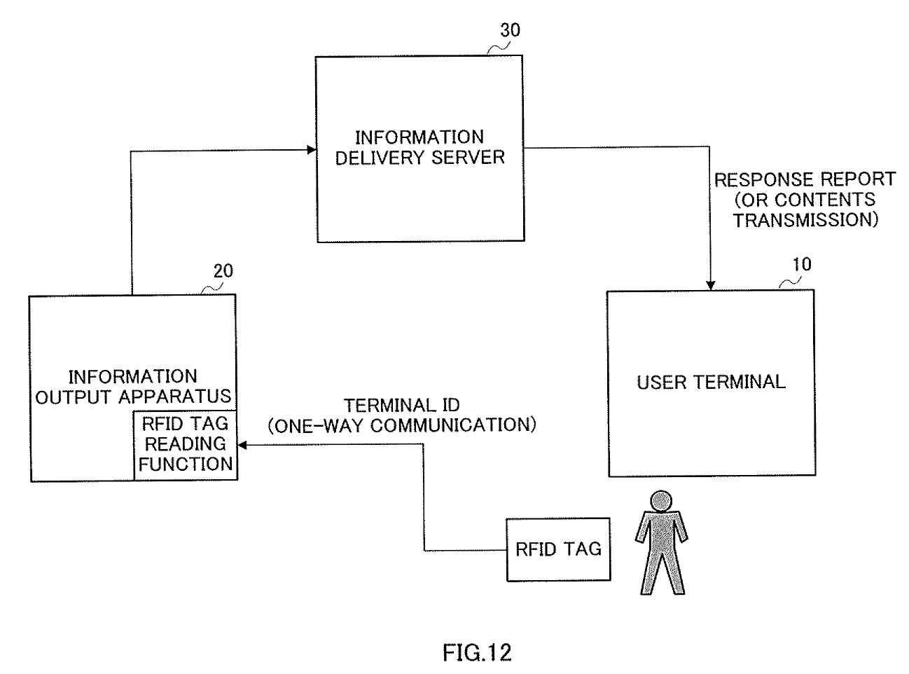

Furthermore, the RFID tag that stores information such as the terminal ID of this user terminal 10 may be attached to the body of the user as shown in FIG. 12 instead of being provided on the body section of user terminal 10.

The processing steps when user terminal 10 or the user stores the RFID tag correspond to the processing steps in FIG. 9 or FIG. 10 where the positions of information output apparatus 20 and user terminal 10 are switched around.

In this way, by using the RFID tag and the RFID tag reading section as the direct communication sections, it is possible to simply construct an apparatus collaboration control system.

The case where the RFID tag and the RFID tag reading section are used has been shown here, but it is likewise possible to use a barcode or two-dimensional code which is patterned identification information and a reading apparatus thereof. In this specification, the RFID tag, barcode, two-dimensional code or the like will be referred to as a “non-contact information transmission medium.”

### EMBODIMENT 5

In embodiment 5 of the present invention, an apparatus collaboration control system which displays contents selected based on user information on user terminal 10 will be explained. The apparatus collaboration control system in this embodiment has a basic configuration similar to that of embodiment 1, and therefore the same or corresponding components are assigned the same reference numerals and detailed explanations thereof will be omitted.

Here, a case will be explained where an advertisement of a car is displayed on information output apparatus 20 and more detailed contents corresponding to the user's preferences are displayed on user terminal 10 when the user approaches the information output apparatus.

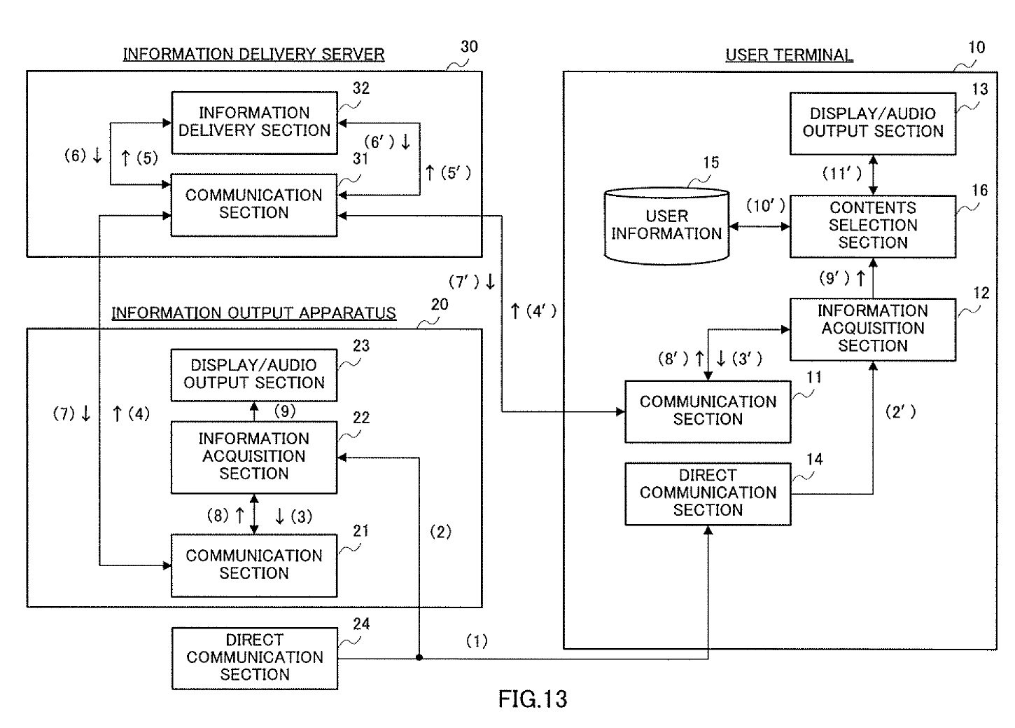

In this system, as shown in FIG. 13, user terminal 10 is provided with user information database (DB) 15 that stores the user's personal information and contents selection section 16 that selects contents delivered from information delivery server 30 based on the user information. Display/audio output section 13 of user terminal 10 displays only contents selected by contents selection section 16. The rest of the configuration is the same as that of embodiment 1 (FIG. 2).

User information DB 15 of user terminal 10 stores information such as the user's gender, age, preferences as user information.

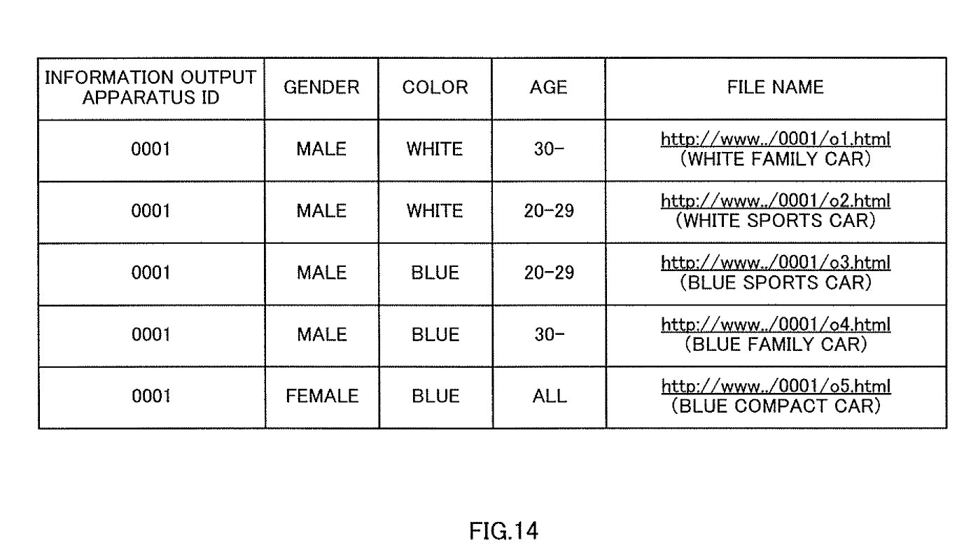

Furthermore, information delivery section 32 of information delivery server 30 manages contents associated with user information as well as the information output apparatus ID, status flag and client type. FIG. 14 shows management information of advertisement information (contents) of cars associated with gender, favorite color, age as an example. Though FIG. 14 omits descriptions of a status flag and a client type, suppose all status flags are set to “ON” (start) and all client types are set to “o” (information output apparatus) and “u” (user terminal).

Processing steps in this system are shown with numerals in parentheses in FIG. 13. This processing flow is basically the same as that in embodiment 1, and with communication with direct communication section 14 of user terminal 10 as a trigger, direct communication section 24 of information output apparatus 20 transmits the information output apparatus ID and URI of information delivery server 30 to user terminal 10 ((1)). Next, information output apparatus 20 transmits an information acquisition request including the information output apparatus ID, status flag (start) and client type (information output apparatus) to information delivery server 30 and information delivery section 32 of information delivery server 30 searches for contents from the management information (FIG. 14) using the information output apparatus ID, status flag (start) and client type (information output apparatus) as keys ((2) to (5)).

At this time, when the contents managed according to the management information (FIG. 14) include a plurality of contents to which all the information output apparatus ID, status flag (start) and client type (information output apparatus) included in the information acquisition request correspond, information delivery section 32 selects arbitrary one of those contents as the content for information output apparatus 20. In the example in FIG. 14, all five contents are applicable and therefore any one of the five contents is selected. Or it is also possible to add weighting information to each content beforehand (for example, a heavier weight is placed on an advertisement to be particularly recommended.) Contents with heavier weights may be preferentially selected as the content for information output apparatus 20.

Communication section 31 of information delivery server 30 sends back the contents selected by information delivery section 32 to information output apparatus 20 and information output apparatus 20 displays contents acquired from information delivery server 30 on display/audio output section 23 ((6) to (9)). The contents sent back at this time may be either the entity the contents or the URI of the contents.

Furthermore, user terminal 10 sends an information acquisition request including the information output apparatus ID, status flag (start) and client type (user terminal) to information delivery server 30 using a procedure similar to that in embodiment 1 ((2′) to (5′)) and information delivery section 32 of information delivery server 30 searches for contents from the management information (FIG. 14) using the information output apparatus ID, status flag (start) and client type (user terminal) as keys.

At this time, when the contents managed according to the management information (FIG. 14) include a plurality of contents to which all the information output apparatus ID, status flag (start) and client type (user terminal) included in the information acquisition request correspond, information delivery section 32 sends all the plurality of contents together with attribute information (information such as gender, color, age) of those contents to communication section 31. In the example in FIG. 14, all the five contents are applicable, and therefore the five contents and information on the gender, color, age are sent to communication section 31. Communication section 31 sends back the information sent from information delivery section 32 to user terminal 10 ((71′)). The contents sent back at this time may be either the entity of the contents or the URI of the contents.

Communication section 11 of user terminal 10 receives the information and sends the information to information acquisition section 12 ((8′)), and information acquisition section 12 sends the plurality of contents and their attribute information to contents selection section 16 ((9′)).

With reference to user information 15 ((10′)), contents selection section 16 compares (matching) the attribute information on the received contents with the user information and determines contents to be displayed.

As a technique for matching, for example, the following technique can be adopted.

A score of matching with respect to a condition is calculated for each attribute. Assuming that the score is 1 in the case of a match, the score is 0 in the case of a mismatch and the score is 0.5 when the user information cannot be acquired and match/mismatch is unclear, scores are added up. At this time, a weight may be assigned to each attribute beforehand and reflected in each score. A content with the highest total score is selected. When a plurality of contents exist for the score, an arbitrary content of them is selected.

Now, suppose the following data is stored as the user information of user terminal 10.

| Attribute | value |
|---|---|
| Name | Taro Matsushita |
| Age | 30 |
| Gender | male |
| Favorite color | blue |

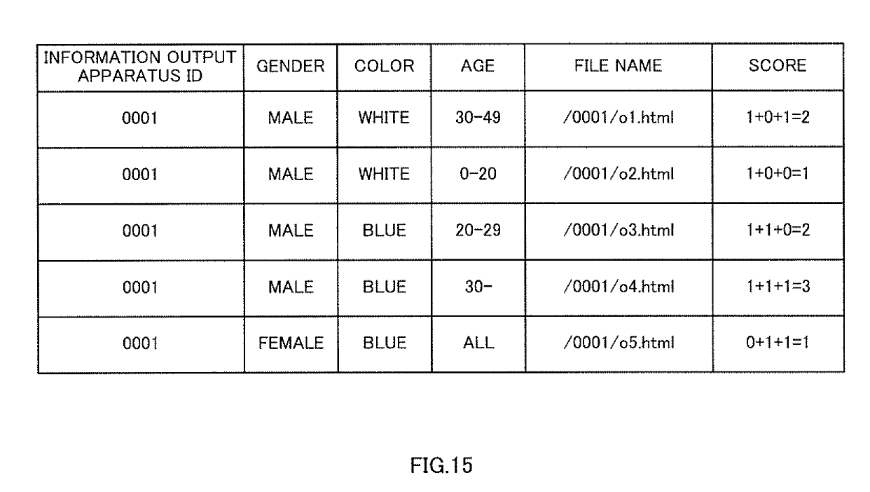

Scores of the respective contents at this time are calculated as shown in FIG. 15 and o4.html is selected as a content to be displayed.

Or it is also possible to rank a plurality of contents in order of scores, display the contents ranking so that the user selects one.

Contents selection section 16 sends the selected content to display/audio output section 13 and display/audio output section 13 displays this content ((11′)).

In this way, according to this apparatus collaboration control system, user information is not revealed outside and personal information of the user can be displayed on user terminal 10.

### EMBODIMENT 6

In embodiment 6 of the present invention, an apparatus collaboration control system will be explained in which user terminal 10 that stores user information selects a content to be displayed on information output apparatus 20 based on the user information. The apparatus collaboration control system in this embodiment has a basic configuration similar to that of embodiment 1, and therefore the same or corresponding components are assigned the same reference numerals and detailed explanations thereof will be omitted.

In this system, as shown in embodiment 3 (FIG. 6), contents displayed by information output apparatus 20 are sent from information delivery server 30 to information output apparatus 20 through user terminal 10. User terminal 10 selects contents to be transferred to this information output apparatus 20 based on the user information,

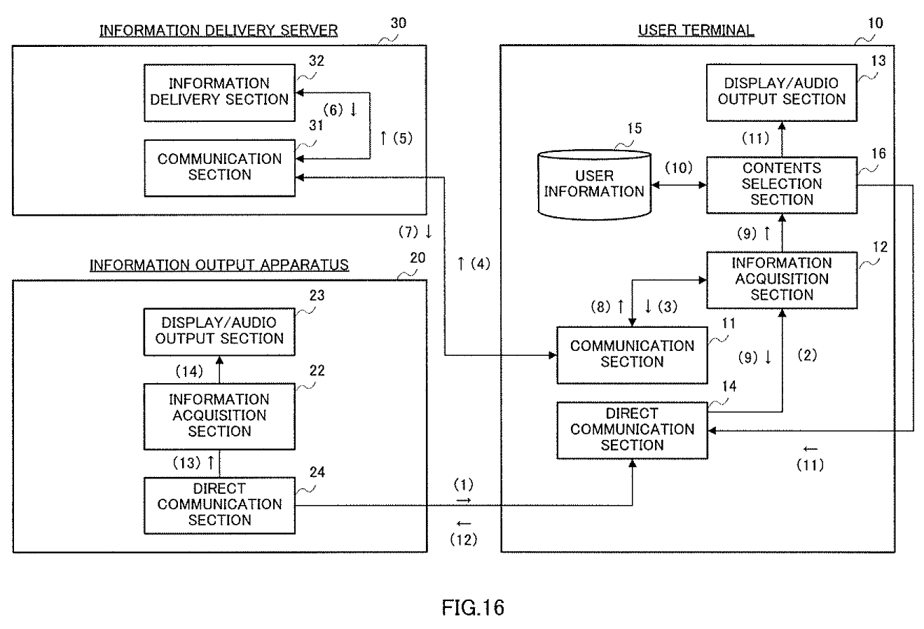

In this system as shown in FIG. 16, information output apparatus 20 includes no section for communicating with information delivery server 30. The rest of the configuration is the same as that of embodiment 5 (FIG. 13).

Next, the operating procedure of this system will be explained.

Direct communication section 24 of information output apparatus 20 transmits the information output apparatus ID and URI of information delivery apparatus 30 to direct communication section 14 of user terminal 10 which has entered its communication range and user terminal 10 transmits an information acquisition request including the information output apparatus ID, status flag (start) and client type (information output apparatus and user terminal) to information delivery server 30 ((1) to (4))

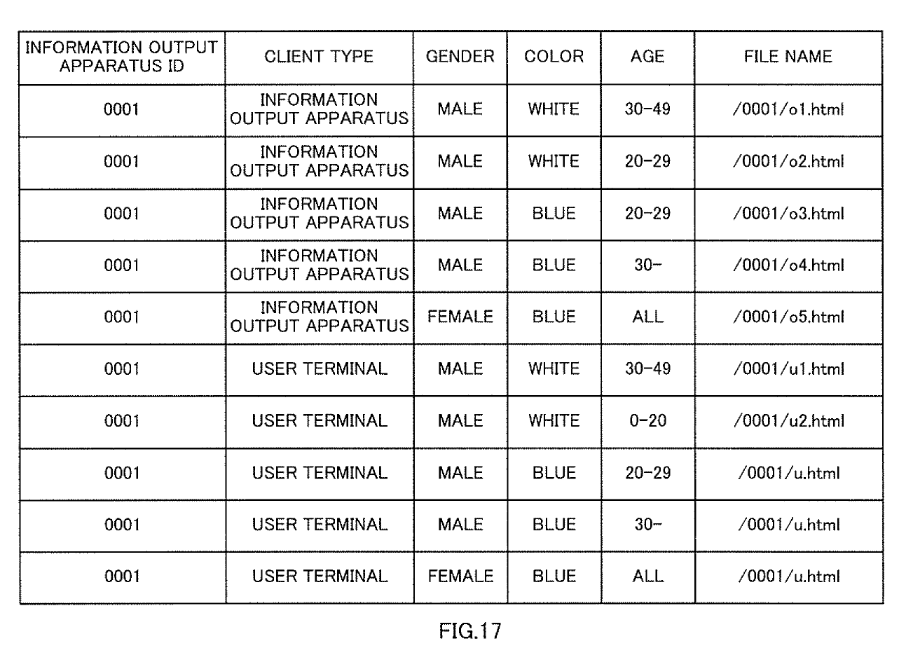

Suppose information delivery section 32 of information delivery server 30 manages information shown in FIG. 17 as management information. Information delivery section 32 which has received the information acquisition request from communication section 31 searches for contents from the management information (FIG. 17) using the information output apparatus ID, status flag (start) and client type (information output apparatus and user terminal) as keys ((5)) and sends all the corresponding contents together with attribute information (information on gender, color, age or the like) of the contents to communication section 31 ((6)). in the example in FIG. 17, all contents are applicable, and therefore the respective contents and information such as the gender, color, age are sent to communication section 31.

Communication section 31 sends back the information sent from information delivery section 32 to user terminal 10 ((7)). The contents to be sent back this time may be either the entity of the contents or the URI of the contents.

Communication section 11 of user terminal 10 receives the information and sends the information to information acquisition section 12 ((8)) and information acquisition section 12 transmits the plurality of contents and their attribute information to contents selection section 16 ((9)).

Contents selection section 16 refers to user information 15 ((10)), compares (matching) the attribute information on the received contents with the user information and determines contents to be displayed on user terminal 10 and information output apparatus 20 respectively.

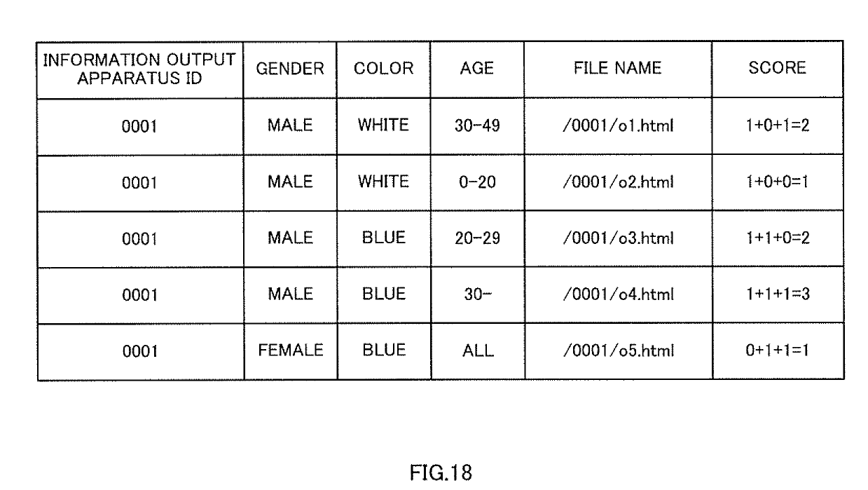

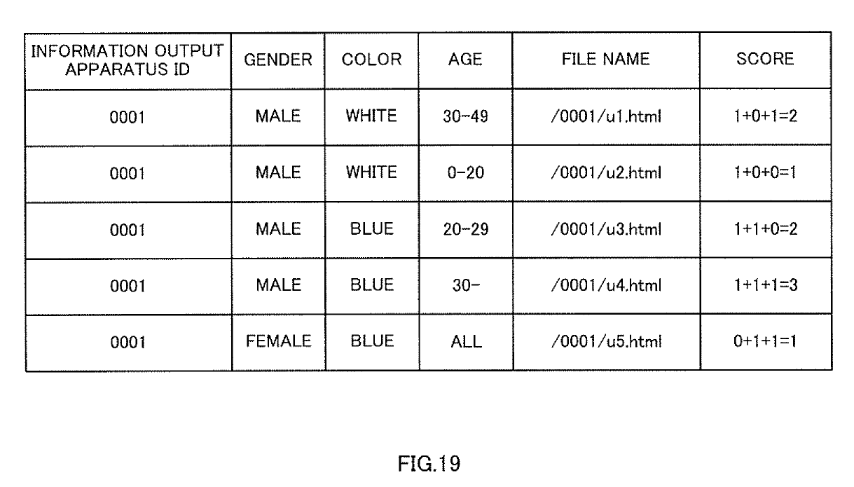

Now, suppose the user information is the same as that in embodiment 5. A score of each of content whose client type is an information output apparatus is calculated as shown in FIG. 18 and o4.Html is selected as the content to be displayed on information output apparatus 20. Furthermore, the scores of contents whose client type is user terminal is calculated as shown in FIG. 19 and u4.Html is selected as the content to be displayed on user terminal 10.

Contents selection section 16 passes the contents selected for user terminal 10 to display/audio output section 13. Display/audio output section 13 displays the contents. Furthermore, contents selection section 16 passes the contents selected for information output apparatus 20 to direct communication section 14 and instructs transmission of the contents to information output apparatus 20 ((11)),

Direct communication section 14 transmits the contents for information output apparatus 20 to information output apparatus 20 ((12)).

Direct communication section 24 of information output apparatus 20 passes the received contents to information acquisition section 22 ((13)) and information acquisition section 22 outputs the contents to display/audio output section 23 to display the contents ((14)).

Thus, this apparatus collaboration control system is able to display contents that match the user's preferences on information output apparatus 20 without revealing user information outside.

User information DB 15 and contents selection section 16 may also be disposed on information delivery server 30, information output apparatus 20 or other servers in addition to user terminal 10. Furthermore, user information DB 15 and contents selection section 16 may also be disposed on different apparatuses.

### EMBODIMENT 7

In embodiment 7 of the present invention, an apparatus collaboration control system will be explained that adaptively distributes information to be displayed by information output apparatus 20 and information to be displayed by user terminal 10 according to respective functions and conditions. The apparatus collaboration control system in this embodiment has a basic configuration similar to that of embodiment 1, and therefore the same or corresponding components are assigned the same reference numerals and detailed explanations thereof will be omitted.

User terminals 10 have different communication speeds, display functions (resolution and number of colors), processing speeds and some user terminals have an audio output function and others do not. In this system, when, for example, user terminal 10 that has responded has no audio output function, information output apparatus 20 performs the audio output, while user terminal 10 displays only images. On the other hand, when user terminal 10 has an audio output function, user terminal 10 performs audio output, while information output apparatus 20 displays only images, In this way a plurality of apparatuses operate in collaboration with each other and efficiently present information.

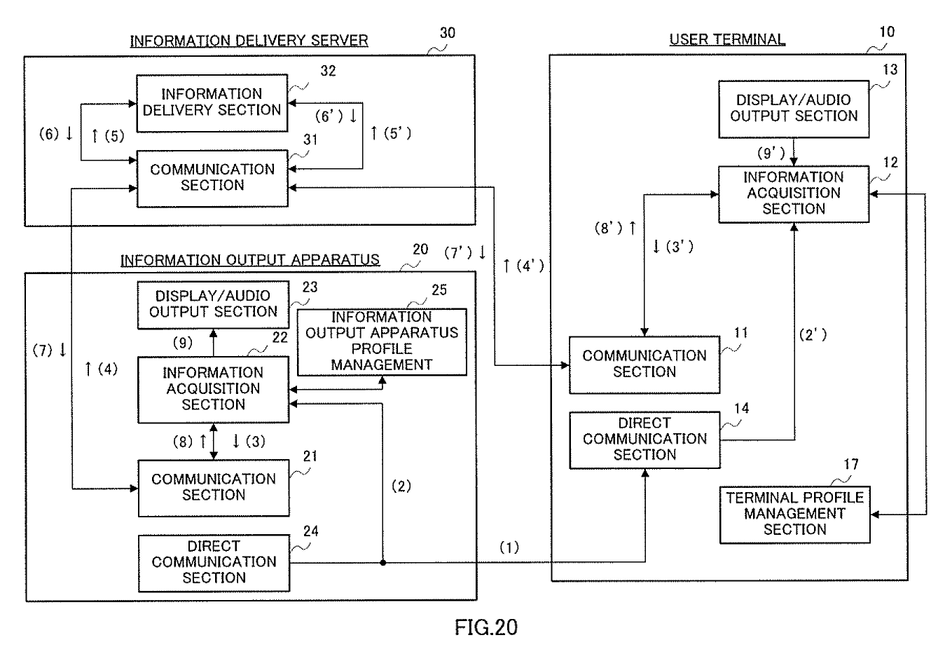

In this system, as shown in FIG. 20, user terminal 10 is provided with terminal profile management section 14 that manages a profile of user terminal 10, and information output apparatus 20 is provided with information output apparatus profile management section 24 that manages a profile of information output apparatus 20. Furthermore, information delivery section 32 of information delivery server 30 manages pair information for contents to be displayed on information output apparatus 20 and contents to be displayed on user terminal 10 as management information. The rest of the configuration is the same as that of embodiment 1 (FIG. 2).

Suppose information output apparatus profile management section 24 manages information of
“information output apparatus profile: audio output function provided”
   and terminal profile management section 14 manages information of
“terminal profile: audio output function not provided.”

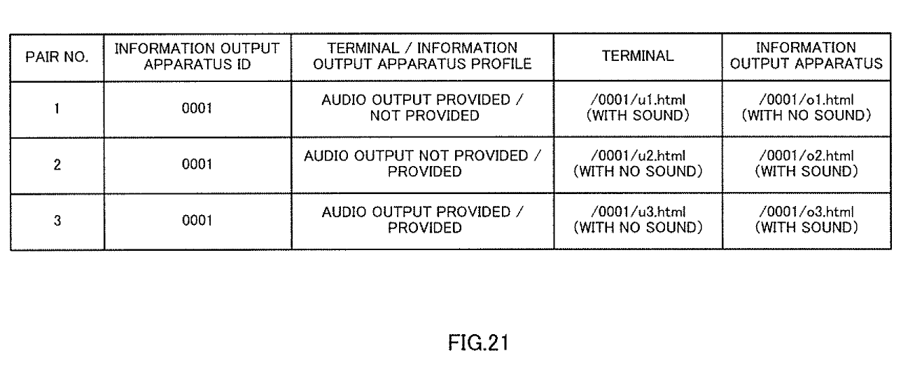

Furthermore, information delivery section 32 of information delivery server 30 stores information of a pair of contents for user terminal 10 set according to a combination of a terminal profile and an information output apparatus profile as shown in FIG. 21 as management information and contents for information output apparatus 20. According to this management information, contents corresponding to the respective functions capable of displaying those contents are assigned to user terminal 10 and information output apparatus 20 and an adjustment is made so that the functions of user terminal 10 and information output apparatus 20 do not collide with each other.

Next, an operating procedure of this system will be explained.
(1) Direct communication section 24 of information output apparatus 20 transmits an information output apparatus ID (0001) and URI of information delivery apparatus 30 to direct communication section 14 of user terminal 10 which has started communication.
(2) When direct communication section 24 of information output apparatus 20 reports the occurrence of a response to information acquisition section 22,
(3) Information acquisition section 22 acquires an information output apparatus profile (audio output function provided) from information output apparatus profile management section 25 and instructs communication section 21 to send an information acquisition request including the information output apparatus ID and information output apparatus profile.
(4) Upon receiving this, communication section 21 transmits the information acquisition request including the information output apparatus ID (0001), information out put apparatus profile (audio out put function provided) and client type (information output apparatus) to information delivery server 30.
(5) Communication section 31 of information delivery server 30 passes the received information acquisition request to information delivery section 32.

On the other hand, in user terminal 10,
(2′) Direct communication section 14 reports the information output apparatus ID (0001) and URI of information delivery apparatus 30 to information acquisition section 12.
(3′) Information acquisition section 12 acquires a terminal profile (audio output function provided) from terminal profile management section 17 and instructs communication section 11 to send an information acquisition request including the information output apparatus ID and terminal profile to information delivery server 30.
(4′) Communication section 11 transmits the information acquisition request including the information output apparatus ID (0001), terminal profile (audio output function provided) and client type (user terminal) to information delivery server 30.
(5′) Communication section 31 of information delivery server 30 passes the received information acquisition request to information delivery section 32.
(6′) Information delivery section 32 searches for contents from the management information (FIG. 21) based on the information acquisition request sent from user terminal 10 and information output apparatus 20 using the information output apparatus ID=(0001), profile of the terminal/information output apparatus=(audio output provided/audio output provided) as keys and returns contents for the user terminal (u3.Html (with no sound)) and contents for the information output apparatus (o3.Html (with sound)) to communication section 31 as the search result.

The subsequent operations are the same as those in embodiment 1, contents for the user terminal (u3.Html (with no sound)) are sent to user terminal 10, displayed from display/audio output section 13, contents for the information output apparatus (o3.Html (with sound)) are sent to information output apparatus 20 and displayed from display/audio output section 23.

In this case, both user terminal 10 and information output apparatus 20 have an audio output function, but since the display of contents with sound is assigned to information output apparatus 20 and the display of contents with no sound is assigned to user terminal 10 according to the management information (FIG. 21), it is possible to avoid a situation where sounds from both apparatuses collide with each other and become offensive to the ear.

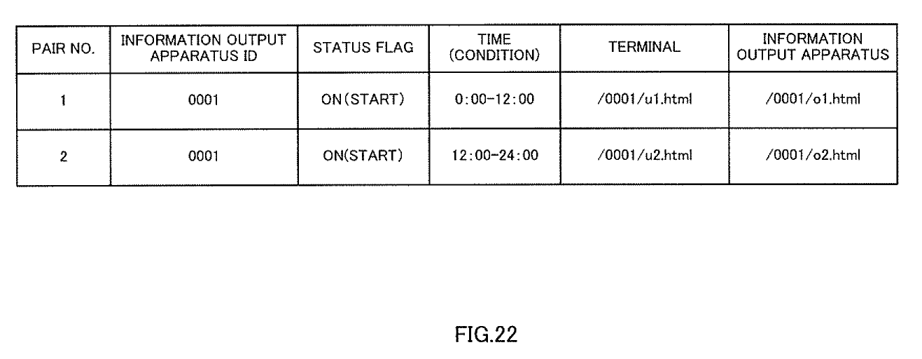

Furthermore, the case has been explained where with attention focused on the functions of user terminal 10 and information output apparatus 20, contents to be displayed are adjusted by both functions. However, with the settings of management information, it is also possible to switch between contents displayed on user terminal 10 and contents displayed on information output apparatus 20 according to time zones, weather, seasons or the like. FIG. 22 shows management information when contents displayed on user terminal 10 and contents displayed on information output apparatus 20 are switched using the time as a condition.

Thus, according to this apparatus collaboration control system, a plurality of collaborating apparatuses can efficiently display contents according to their respective functions and conditions/

### EMBODIMENT 8

In embodiment 8 of the present invention, an apparatus collaboration control system will be explained in which a marking (bookmark) function is added to a user terminal. The apparatus collaboration control system in this embodiment has a basic configuration similar to that of embodiment 1, and therefore the same or corresponding components are assigned the same reference numerals and detailed explanations thereof will be omitted.

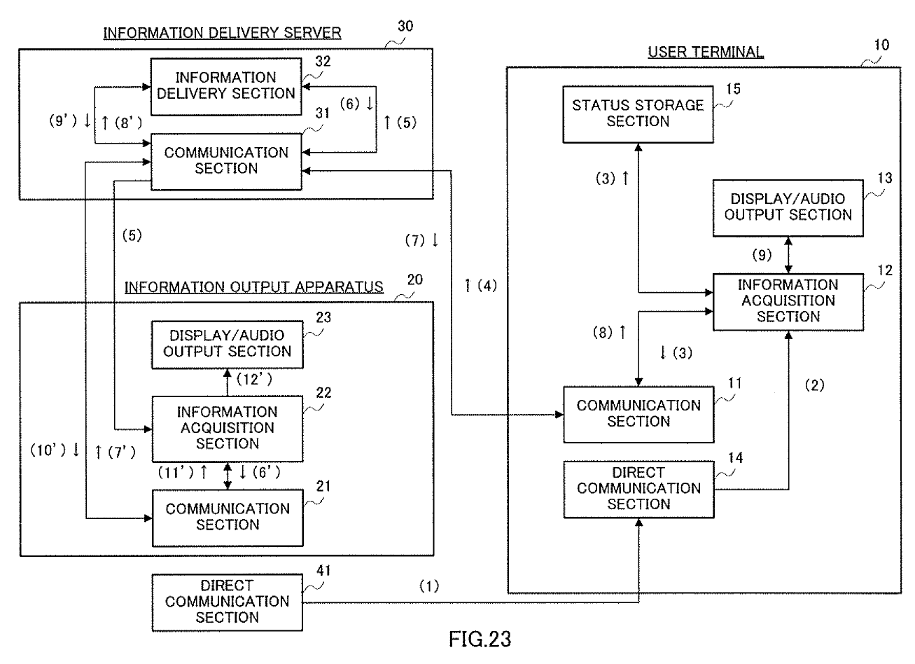

In this system, as shown in FIG. 23, user terminal 10 is provided with status storage section 18 that stores an information output apparatus ID and additional information related thereto. User terminal 10 is able to acquire information from information delivery server 30 on a later date once again using the information output apparatus ID stored in this status storage section 18. The rest of the configuration is the same as that in embodiment 4 (FIG. 9)

For example, direct communication section 41 is an RFID tag attached to clothes and in addition to the information output apparatus ID and URI of information delivery server 30, additional information such as price of the clothes, location of the store is embedded in this RFID tag.

When a user who carries user terminal 10 approaches the clothes, communication between direct communication section 14 of user terminal 10 and the RFID tag is started using a procedure expressed with numerals in parentheses in FIG. 23, various types of information embedded in the RFID tag are received by direct communication section 14 of user terminal 10 ((1)), sent to information acquisition section 12 ((2)) and stored in status storage section 18 ((3)). At this time, it is also possible to display a menu for selecting “marking needed/not needed” on display/audio output section 13, wait for an explicit selection operation by the user and store the information in status storage section 18.

Furthermore, information acquisition section 12 of user terminal 10 which has acquired the information output apparatus ID presents this information output apparatus ID using the procedure explained in embodiment 4, acquires contents from information delivery server 30 ((3) to (8)) and displays the contents on display/audio output section 13 ((9)). In this way, user terminal 10 displays a still image of, for example, the clothes sent from information delivery server 30.

Furthermore, information delivery server 30 which has acquired information from user terminal 10 reports the occurrence of a response to information output apparatus 20 ((5)), information acquisition section 22 of information output apparatus 20 acquires contents from information delivery server 30 ((6′) to (11′)) and display/audio output section 23 displays the contents ((12′)). In this way, information output apparatus (display) 20 displays clothes-related scenes, for example, moving images of a fashion show in which a model wearing the clothes appears.

Furthermore, user terminal 10 can also acquire and display contents for user terminal 10 from information delivery server 30 once again using the information output apparatus ID of the marking information stored in status storage sectional 8 at a different place or different time. At this time, information acquisition section 12 of user terminal 10 displays the marking information stored in status storage section 18 on display/audio output section 13, waits for an explicit selection operation by the user and requests information delivery server 30 for contents for user terminal 10. Furthermore, when a plurality of pieces of marking information is stored in status storage section 18, information acquisition section 12 displays the marking information in a list and waits for a selection operation by the user. At this time, it is also possible to rank (in the case of clothes, for example, they are arranged and displayed in order of prices) or group (divide by type of clothes) the pieces of marking information based on additional information so that the marking information can be easily compared.

Information acquisition section 12 of user terminal 10 sends an information acquisition request including the information output apparatus ID of the marking information selected by the user to information delivery server 30. Information delivery server 30 selects contents to be delivered to user terminal 10 based on this information output apparatus ID. The selected contents are sent to user terminal 10 and displayed on display/audio output section 13.

In this case, information delivery server 30 does not report the occurrence of a response to information output apparatus 20. In order to report this to information delivery server 30, flag information for suppressing a status change of information output apparatus 20 is added to the information acquisition request sent from user terminal 10 to information delivery server 30.

Furthermore, it is also possible to store the additional information included in the marking information in information delivery server 30 instead of storing it in the RFID tag and deliver the additional information together with the contents to user terminal 10 according to the information acquisition request of user terminal 10.

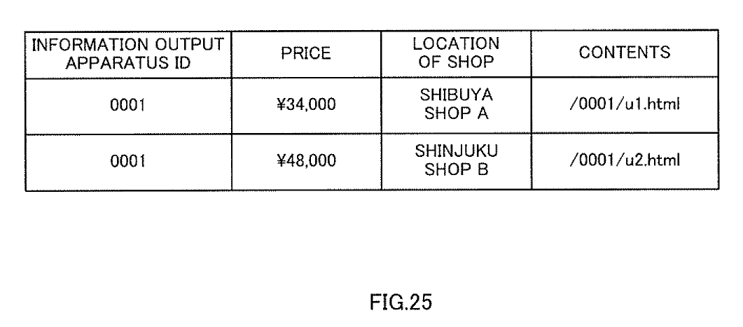

In this case, the management information of information delivery server 30 includes information of prices and locations, and contents as shown in FIG. 25. User terminal 10 acquires information of prices and locations together with the contents from information delivery server 30. The contents are outputted to display/audio output section 13 and information of prices and locations is stored together with the information output apparatus ID in status recording section 18 when a menu for selecting “marking needed/not needed” is displayed and the user explicitly selects either one.

When user terminal 10 acquires information of information output apparatus ID=0001 from the RFID tag and sends an information acquisition request to information delivery server 30, display/audio output section 13 of user terminal 10 displays detailed information of clothes (0001/u.html) and at the same time the price “¥34,000” and location of the shop: Shibuya Shop A are stored in status storage section 18.

Furthermore, when information output apparatus ID=0002 is acquired by communicating with another RFID tag (other clothes are marked at another shop), display/audio output section 13 of user terminal 10 displays detailed information of the clothes (0002/u.html) and at the same time the price “¥48,000” and location of the shop: Shinjuku Shop B are stored in status storage section 18.

Furthermore, when there is a change in the additional information stored in status storage section 18 (for example, the price of the clothes is lowered), this change can be reported to the user using the following method.

(Method 1: Polling from Terminal)

User terminal 10 receives additional information from information delivery server 30 using the information output apparatus ID stored in status storage section 18 as a key. When the information is different from the additional information stored in user terminal 10, the change is reported to the user. The reporting to the user may be performed by mail or display of a report screen.

(Method 2: Report from Server)

When there is a change in the additional information, a setting is made so that information delivery server 30 reports the change.

As such a method, user terminal 10 transmits a list of information output apparatus IDs stored in status storage section 18 to information delivery server 30. Information delivery server 30 manages information of pairs of the information output apparatus IDs and IDs of user terminal 10 storing (marking) the status thereof. When there is a change in the additional information related to the information output apparatus ID, information delivery server 30 identifies user terminal 10 that marks it according to the above described pair information and reports the additional information to user terminal 10. User terminal 10 receives the change contents of the additional information and reports it to the user. The reporting to the user may be performed by mail or display of a report screen.

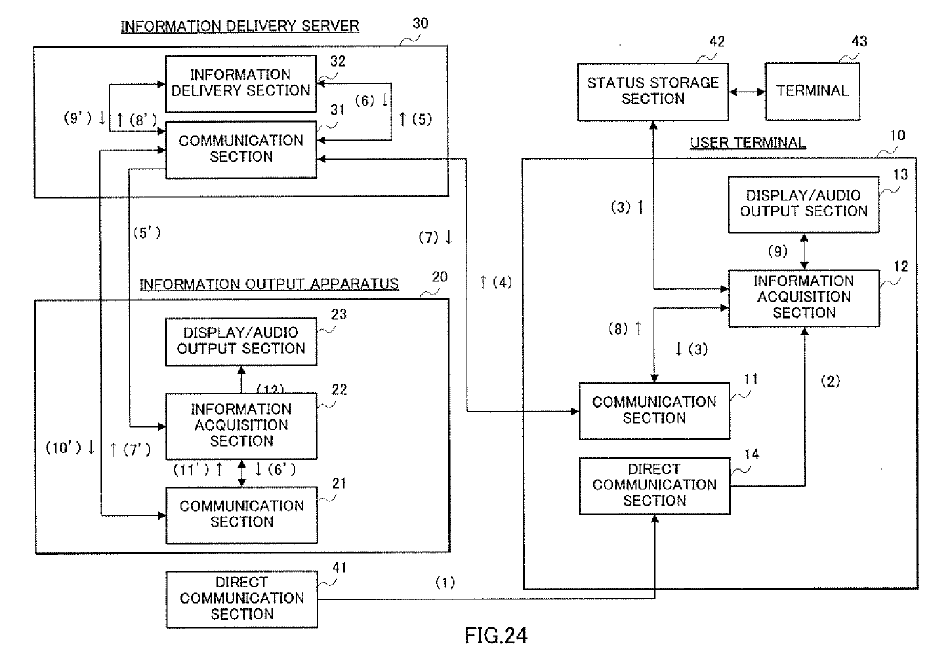

Furthermore, as shown in FIG. 24, status storage section 42 may also be disposed on information delivery server 30 outside user terminal 10 or on other servers. In this case, other user terminal 43 or the like can use marking information stored in status storage section 42 and acquire information from information delivery server 30.

In this way, this system can redisplay contents of marked commodities or the like at an arbitrary place or arbitrary time by storing marking information in user terminal 10 and also compare additional information of marked commodities or the like. For example, it is possible to sort marking information using additional information such as prices so that the user can easily compare prices or the like.

### EMBODIMENT 9

In embodiment 9 of the present invention, an apparatus collaboration control system will be explained in which a plurality of collaborating apparatuses adaptively change their control situations. The apparatus collaboration control system in this embodiment has a basic configuration similar to that of embodiment 1, and therefore the same or corresponding components are assigned the same reference numerals and detailed explanations thereof will be omitted.

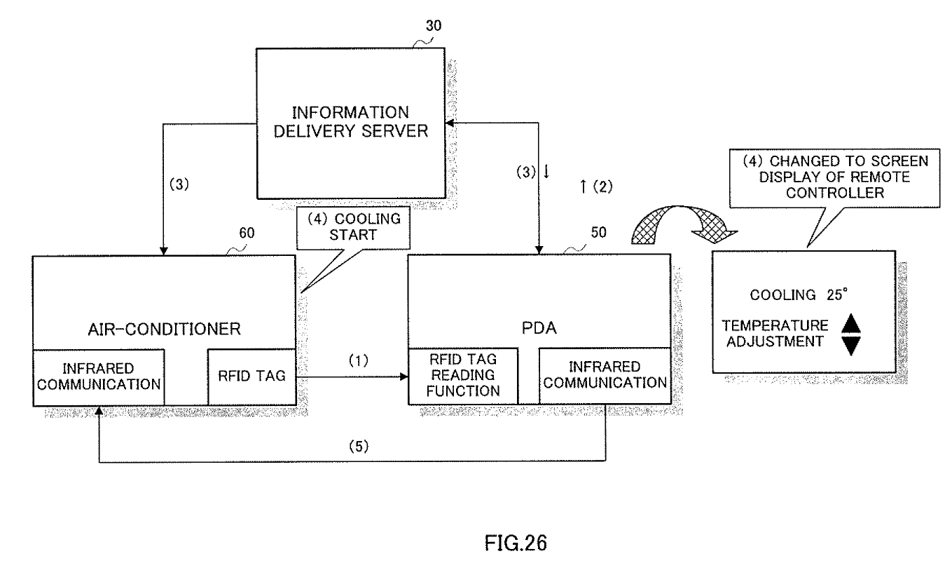

As shown in FIG. 26, this system is provided with PDA 50 which is a user terminal, air-conditioner 60 that outputs cool air or hot air and information delivery server 30 that delivers control information.

This air-conditioner 60 is provided with an RFID tag and an infrared communication function as direct communication sections. Furthermore, PDA 50 is provided with an RFID tag reading function and an infrared communication function as direct communication sections.

Information delivery server 30 receives an information delivery request from PDA 50 and delivers, for example, control program information on a remote controller that controls a temperature setting operation of air-conditioner 60 to PDA 50. Furthermore, information delivery server 30 delivers control operation information for starting up air-conditioner 60 to air-conditioner 60.

Air-conditioner 60 starts operation according to this control operation information and outputs cool air or warm air. That is, this air-conditioner 60 operates in the same way as information output apparatus 20 in that the output is changed according to the information (control operation information) acquired from information delivery server 30 though its output (cool air or hot air/information) is different from information output apparatus 20 shown in the other embodiments.

Next, the operating procedure of this system will be explained.

When the user carrying PDA 50 approaches air-conditioner 60, the RFID tag reading function of PDA 50 reads the apparatus ID (0001) of air-conditioner 60 recorded in the RFID tag of air-conditioner 60 ((1)). PDA 50 sends this apparatus ID and an information delivery request including a status flag indicating a start to information delivery server 30 ((2)).

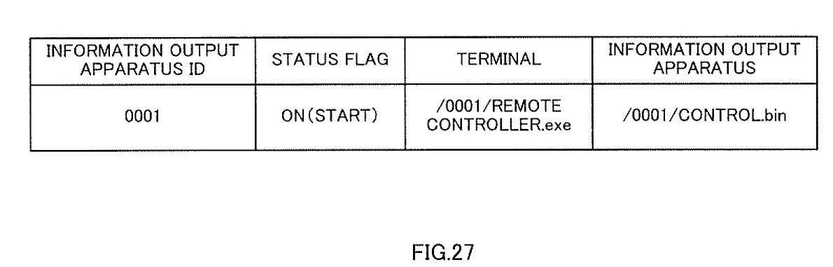

Information delivery server 30 stores management information which defines pair information for information for the PDA (remote controller exe) and information for air-conditioner 60 (control bin) in association with the apparatus ID and status flag (start) as shown in FIG. 27.

Here, “remote controller.exe” denotes a remote controller program operating on a terminal (PDA 50) and “control bin” denotes a file storing the information (cooling: information indicating temperature setting of 25° C. or the like) for controlling the air-conditioner.

Upon receiving the information delivery request from PDA 50, information delivery request information delivery server 30 searches for management information (FIG. 27) using the apparatus ID (0001) and status flag (start) as keys. Then, information delivery server 30 sends information for the PDA of the search result (remote controller.exe) to PDA 50 and sends control information for the air-conditioner (control bin) to air-conditioner 60 ((3)).

Air-conditioner 60 analyzes information contents of control bin and starts cooling according to the contents. On the other hand, PDA 50 which has received the remote controller program operates the program and the screen changes to the screen display of the remote controller ((4)).

Furthermore, when the user operates PDA 50 to adjust the temperature of air-conditioner 60, the information is transmitted from PDA 50 to air-conditioner 60 through infrared communication, the temperature of air-conditioner 60 can be controlled as in the case of a normal remote controller ((5)).

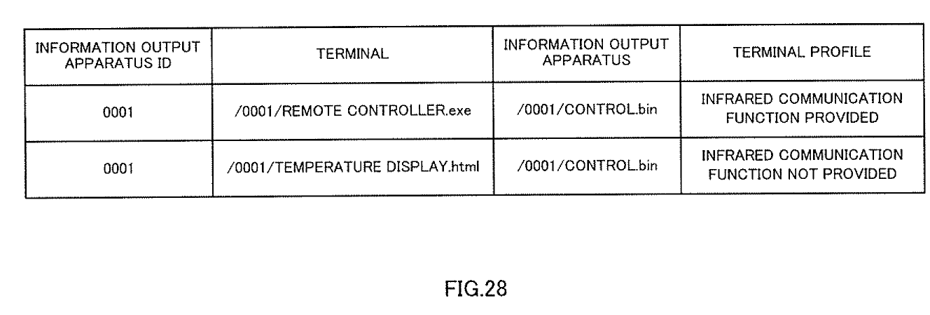

Furthermore, it is also possible to perform such information management that information delivery server 30 can change information to be delivered to PDA 50 according to a terminal profile as shown in FIG. 28. In this cases when PDA 50 has an infrared communication function, a remote controller program (remote controller.exe) is delivered and when PDA 50 does not have any infrared communication function, temperature display.html (content displaying the set temperature) is delivered (assuming that the status flag is “ON”).

In this way, in the apparatus collaboration control system according to this embodiment, a plurality of apparatuses can collaborate with each other to realize adaptive control efficiently.

Examples of apparatuses to be controlled by this apparatus collaboration control system include not only air-conditioners but also various apparatuses such as home electric appliances and machine tools.

Furthermore, for communications between the user terminal, information output apparatus and information delivery server shown in the above described embodiments, it is also possible to perform an authentication procedure such as server authentication or terminal authentication, or communication through encryption.

Furthermore, as explained in embodiment 1, the user terminal may also store the URI of the information delivery server in the other embodiments.

Furthermore, as explained in embodiment 1, instead of including a client type and a status flag in an information acquisition request to the information delivery server, it is also possible to change the URI of an information delivery server to be accessed according to the client type and response status in the other embodiments.

Furthermore, the present invention is not limited to the above described embodiments, but the present invention can be implemented in various embodiments.

For example, the inter-apparatus collaboration method explained in the above described embodiments may also be executed as software on a computer in an inter-apparatus collaboration control system. For example, it is possible to record the program for executing the inter-apparatus collaboration method explained in the above described embodiments in a recording medium such as a ROM (Read Only Memory) beforehand and cause a CPU (Central Processor Unit) to operate the program.

As is clear from the above described explanations, in the apparatus collaboration control system according to the present inventions a plurality of apparatuses collaborate with each other and can thereby adaptively present information and perform efficient and effective control based on control information.

This application is based on the Japanese Patent Application No. 2002-297582 filed on Oct. 10, 2002, entire content of which is expressly incorporated by reference herein

### INDUSTRIAL APPLICABILITY

The present invention is suitable for use as an apparatus collaboration control system capable of delivering various adaptive services efficiently and effectively through a plurality of apparatuses collaborating with each other.

1. An inter-apparatus collaboration method executed between a first apparatus, second apparatus and third apparatus, comprising:
a direct communication step of carrying out direct communication between said first apparatus and said second apparatus;
a delivery step of delivering information used for processing at said first apparatus and said second apparatus from said third apparatus when communication is carried out in said direct communication step; and
an execution step of executing processing based on the information delivered in said delivery step at said first apparatus and said second apparatus,
wherein an output of said first apparatus and an output of said second apparatus through the processing executed in said execution step have different contents.

2. The inter-apparatus collaboration method according to claim 1, further comprising an output step of carrying out predetermined output processing at said first apparatus,
wherein said execution step comprises a switching step of switching contents of the output by the output processing carried out in said output step based on the information delivered in said delivery step.

3. The inter-apparatus collaboration method according to claim 2, further comprising an identification information transmission step of transmitting identification information of at least one of said first apparatus and said second apparatus to said third apparatus,
wherein said delivery step delivers information based on the identification information transmitted in said identification information transmission step.

4. The inter-apparatus collaboration method according to claim 2, wherein:
said direct communication step reports the identification information of said first apparatus from said first apparatus to said second apparatus;
the method further comprises an identification information transmission step of transmitting the identification information reported in said direct communication step from said second apparatus to said third apparatus; and
said delivery step delivers information based on the identification information transmitted in said identification information transmission step.

5. The inter-apparatus collaboration method according to claim 2, wherein:
one of said first apparatus and said second apparatus comprises a non-contact type information medium; and
in said direct communication step, the other of said first apparatus and said second apparatus reads said non-contact type information medium.

6. The inter-apparatus collaboration method according to claim 5, wherein:
said one of said first apparatus and said second apparatus further comprises a body section; and
said non-contact information medium is provided apart from said body section.

7. The inter-apparatus collaboration method according to claim 2, further comprising a function information transmission step of transmitting function information of at least one of said first apparatus and said second apparatus to said third apparatus,
wherein said delivery step delivers information based on the function information transmitted in said function information transmission step.

8. The inter-apparatus collaboration method according to claim 2, wherein:
said direct communication step reports the function information of said first apparatus from said first apparatus to said second apparatus;
the method further comprises a function information transmission step of transmitting the identification information reported in said direct communication step from said second apparatus to said third apparatus; and
said delivery step delivers information based on the identification information transmitted in said identification information transmission step.

9. The inter-apparatus collaboration method according to claim 2, wherein:
said second apparatus stores user information;
the method further comprises an information selection step of selecting at least part of the information delivered in said delivery step based on said user information; and
said execution step executes the processing based on at least part of said information selected in said information selection step at said second apparatus.

10. The inter-apparatus collaboration method according to claim 2, wherein:
said second apparatus stores user information;
the method further comprises an information selection step of selecting at least part of the information delivered in said delivery step based on said user information; and
said execution step executes the processing based on at least part of said information selected in said information selection step at said first apparatus and said second apparatus.

11. The inter-apparatus collaboration method according to claim 2, wherein:
the information delivered in said delivery step comprises operation information on a processing operation at said first apparatus and control information for controlling a processing operation at said first apparatus; and
said execution step carries out the processing based on said operation information at said first apparatus and the processing based on said control information at said second apparatus.

12. The inter-apparatus collaboration method according to claim 2, wherein:
said direct communication step reports additional information necessary to obtain an output of processing executed in said execution step; and
the method further comprises a storing step of storing additional information reported in said direct communication step in said second apparatus.

13. The inter-apparatus collaboration method according to claim 12, wherein said storing step determines whether additional information is stored or not according to the selection operation at said second apparatus.

14. The inter-apparatus collaboration method according to claim 12, further comprising a re-outputting step of re-outputting the output of said second apparatus through the processing executed in said execution step using the additional information stored in said storing step.

15. The inter-apparatus collaboration method according to claim 14, further comprising:
a display step of displaying the additional information stored in said storing step in a comparable manner; and
a display information selection step of selecting at least part of the additional information displayed in said display step,
wherein said re-outputting step uses at least part of said additional information selected in said display information selection step.

16. The inter-apparatus collaboration method according to claim 14, wherein said re-outputting step comprises a control step of controlling switching in said switching step.

17. The inter-apparatus collaboration method according to claim 12, further comprising a discrepancy reporting step of reporting, when there is a discrepancy between contents of the additional information stored in said storing step and contents of information in said third apparatus, the occurrence of said discrepancy to said second apparatus.

18. An inter-apparatus collaboration control system comprising:
a first apparatus and a second apparatus that directly communicate with each other; and
a third apparatus that delivers information used for processing at said first apparatus and said second apparatus when said first apparatus and said second apparatus carry out communication, wherein:
said first apparatus and said second apparatus execute processing based on the information delivered from said third apparatus respectively; and
an output of the processing executed at said first apparatus and an output of the processing executed at said second apparatus have different contents.

19. An inter-apparatus collaboration control program for an inter-apparatus collaboration control system comprising a first apparatus, second apparatus and third apparatus, said inter-apparatus collaboration control program being for realizing:
a direct communication function that carries out direct communication between said first apparatus and said second apparatus;
a delivery function that delivers information used for processing at said first apparatus and said second apparatus from said third apparatus when communication by said direct communication function is carried out; and
an execution function that executes the processing based on the information delivered from said delivery function at said first apparatus and said second apparatus,
wherein an output of said first apparatus through the processing executed by said execution function and an output of said second apparatus have different contents.

20. A terminal apparatus comprising:
a direct communication section that carries out direct communication with another terminal apparatus;
an acquisition section that acquires information delivered from a server apparatus when communication is carried out by said direct communication section; and
an execution section that executes processing based on the information acquired by said acquisition section,
wherein an output of the processing executed by said execution section and an output of said another terminal apparatus through the processing based on the information delivered from said server apparatus to said another terminal apparatus have different contents.
